(19) United States
(12) Patent Application Publication
(10) Pub. No.: US 2026/0352907 A1
(43) Pub. Date: Nov. 5, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Asuka ISHII, Tokyo (JP); Hiroo Ikeda, Tokyo (JP)

(73) Assignee: NEC Corporation, Tokyo (JP)

(21) Appl. No.: 19/649,290

(22) Filed: Apr. 16, 2026

(30) Foreign Application Priority Data
Apr. 30, 2025 (JP) 2025-075108

(51) Int. Cl. H04N 21/254; G06N 3/0455; G06T 7/70; G06V 10/74; G06V 10/77; G06V 40/20

(52) U.S. Cl. CPC H04N 21/2541; G06N 3/0455; G06T 7/70; G06V 10/761; G06V 10/7715; G06V 40/23; G06T 2207/30196

(57) ABSTRACT

An information processing device according to the present disclosure includes a posture detection unit, a choreography digitalization unit, a similarity determination unit, and a rights management unit. The posture detection unit detects posture data of a person from a moving image. The choreography digitalization unit extracts a feature value of a choreography from the detected posture data and registers the feature value in a database. The similarity determination unit calculates a similarity between the choreography registered in the database and a new choreography. The rights management unit evaluates the possibility of copyright infringement based on the similarity.

This application is based upon and claims the benefit of priority from Japanese patent application No. 2025-75108, filed on Apr. 30, 2025, the disclosure of which is incorporated herein in its entirety by reference.

### TECHNICAL FIELD

The present disclosure relates to an information processing device, an information processing method, and a non-transitory computer-readable medium.

### BACKGROUND ART

In content generation, there is a technique for converting an object in the real world into data. For example, JP 2019-071008 A discloses a technique related to a detection device and a detection method including a neural network that performs a convolution processing on time and space from image or moving image data and three-dimensional distance data using skeleton data of an object.

### SUMMARY

In recent years, with the development of computer vision and machine learning techniques, it has become possible to quantitatively evaluate human motion. An object of this disclosure is to develop a technique that utilizes a quantitative evaluation result of human motion.

According to one aspect of an example of the present disclosure,
there is provided an information processing device including
a posture detection means for detecting posture data of a person from a moving image,
a choreography digitalization means for extracting a feature value of a choreography from the detected posture data and registering the feature value in a database,
a similarity determination means for calculating a similarity between the choreography registered in the database and a new choreography, and
a rights management means for evaluating a possibility of copyright infringement based on the similarity.

Furthermore, according to one aspect of an example of the present disclosure,
there is provided an information processing method in which one or more computers
detect posture data of a person from a moving image,
extract a feature value of a choreography from the detected posture data and register the feature value in a database,
calculate a similarity between the choreography registered in the database and a new choreography, and
evaluate a possibility of copyright infringement based on the similarity.

In addition, according to one aspect of an example of the present disclosure,
there is provided a program for causing a computer to function as
a posture detection means for detecting posture data of a person from a moving image,
a choreography digitalization means for extracting a feature value of a choreography from the detected posture data and registering the feature value in a database,
a similarity determination means for calculating a similarity between the choreography registered in the database and a new choreography, and
a rights management means for evaluating a possibility of copyright infringement based on the similarity.

According to an example of this disclosure, it is possible to develop a technique that utilizes a quantitative evaluation result of human motion.

### BRIEF DESCRIPTION OF THE DRAWINGS

FIG. 1 is an example of an overview diagram of an entire system;

FIG. 2 is an example of a system architecture diagram;

FIG. 3 is an example of a definition diagram of skeleton points and joints;

FIG. 4 is a diagram illustrating an example of a flow of processing of posture detection;

FIG. 5 is a diagram illustrating an example of a flow of processing of a choreography digitalization function;

FIGS. 6A to 6D are examples of an expressive method diagram of a choreography feature value;

FIGS. 7A to 7C are examples of an overview diagram of a similarity calculation algorithm;

FIG. 8 is a diagram illustrating an example of a flow of processing of a similarity determination process;

FIG. 9 is an example of a determination criterion diagram of copyright infringement evaluation;

FIG. 10 is an example of a configuration diagram of rights management using a blockchain;

FIG. 11 is an example of an explanatory diagram of a reward distribution mechanism;

FIG. 12 is an example of a conceptual diagram of joint copyright management;

FIG. 13 is an example of an application diagram of the choreography data to the avatar;

FIG. 14 is an example of a diagram for providing the choreography analysis and the learning support information;

FIG. 15 is an example of a conceptual diagram of a choreography value measurement and automatic pricing system;

FIG. 16 is an example of a configuration diagram of a choreography search system using a natural language;

FIG. 17 is an example of a configuration diagram of a choreography generation system;

FIG. 18 is an example of a pruning function diagram for copyright infringement avoidance in the choreography generation;

FIG. 19 is an example of an explanatory diagram of a choreography deformation function for copyright infringement avoidance;

FIGS. 20A to 20D are examples of a user interface of the system;

FIG. 21 is a diagram illustrating an example of a flow of processing of a choreography copyright management system utilizing a posture estimation technique;

FIG. 22 is an example of a functional block diagram of an information processing device;

FIG. 23 is a diagram illustrating an example of a flow of processing of the information processing device; and

FIG. 24 is a diagram illustrating an example of a hardware configuration of a device.

### EXAMPLE EMBODIMENT

Hereinafter, an example embodiment of the present disclosure will be described with reference to the drawings. In this disclosure, the drawings are associated with one or more example embodiments. In all the drawings, similar components are denoted by similar reference signs, and descriptions thereof will be omitted as appropriate. The illustrated content is an example, and the content of this example embodiment is not limited to the illustrated content.

### First Example Embodiment

### Premise

A premise in this example embodiment will be described. In recent years, with the development of computer vision and machine learning techniques, posture estimation technique for recognizing and analyzing human motions in a three-dimensional space has greatly advanced. These techniques are capable of not only detecting movement but also quantitatively evaluating characteristics and quality of the movement. This example embodiment focuses on the possibility of applying such a posture estimation technique to economic value creation.

As an example, in the content industry so far, the value of body expression such as dance and choreography has been determined based on subjective evaluation, and a system of objective evaluation and rights management has not been sufficiently established. However, with the development of the posture estimation technique, the body motion can be regarded as numerical data, and the characteristics and quality thereof can be objectively analyzed, so that the possibility of creating new value is created.

In this example embodiment, it is aimed to construct an economical mechanism that evaluates the characteristics and quality based on the motion data acquired using the posture estimation technique, and returns an appropriate reward to the creator and the performer based on the evaluation result. Here, a Virtual YouTuber (VTuber) market is taken as an example, and a system that appropriately manages a copyright of choreography created by a choreographer and achieves reward distribution according to use by the VTuber or the dancer is proposed. VTuber is a moving image distributor that performs video distribution or live distribution using a 2D or 3D avatar or the like on YouTube (registered trademark). Application of the technique of this example embodiment is not limited to the VTuber market, and can be applied to other video distribution markets in which video distribution or live distribution is performed using a 2D or 3D avatar or the like in other video distribution platforms (the same applies to all the following example embodiments).

The application range of this example embodiment is not limited to the VTuber market or the content industry. For example, in the entertainment field, in a dance game, a fitness application, or the like, a mechanism of accurately evaluating the movement of the user and returning the result of the game or the degree of health promotion as a reward can be considered. In such an environment, protection and management of complex intellectual property rights such as a patent of a game design, a copyright of an algorithm, and a trademark of a service are required.

Alternatively, in the medical field, it can be utilized for training of rehabilitation techniques of physical therapists and nurses and assistance methods for patients. It is possible to support improvement of the technique of the medical practitioner and to construct an incentive system according to the technical level by quantitatively evaluating the correct motion and providing an appropriate feedback. In this case, it is possible to apply the evaluation criteria based on legal regulations related to medical practice and medical ethic guidelines.

Also in the nursing care field, it can be utilized as a tool for evaluating the efficiency and safety of the motion of a nursing care worker and promoting acquisition of an appropriate nursing care technique. Since the quality of work is directly linked to the safety and comfort of the user at the nursing care site, it is expected to establish a technical certification and a reward system based on the motion evaluation. At this time, the system functions as an evaluation system conforming to the Long-term Care Insurance Act and quality standards of welfare services.

In the sports field, it can be applied to form analysis of athletes and quantitative evaluation of training effects, and can also be used to improve the quality of coaching and evaluate the value of players. The system also functions as an evaluation system incorporating unique criteria such as rules and guidelines of each league association and anti-doping regulations.

In the education field, a system that evaluates a motion of a learner in a dance or physical education class and provides advice according to an individual progress degree is considered. Appropriate instruction and evaluation according to the educational goal can be made by applying the evaluation criteria based on the Learning Guidance Procedure and the education policy unique to the educational institution.

In addition, in this example embodiment, a function of detecting and preventing copyright infringement is described as an example, but applicable standards and norms are not limited to copyright laws. The system is compatible with not only copyright but also other intellectual property laws. In addition, it is designed to be adaptable to norms that are not legally binding, such as guidelines, ethical standards, and platform-specific terms of use that are independently formulated by industry association. For example, industry voluntary regulations relating to the choreography of a specific genre, expression guidelines based on cultural/religious considerations, special regulations in use for educational purposes, and the like can also be incorporated as the evaluation criteria.

As described above, the technique and the system aimed by this example embodiment are bases for quantitatively evaluating the human motion in various industrial fields and providing appropriate economic rewards and incentives based on the evaluation. Furthermore, by providing a mechanism capable of flexibly responding to various normative systems such as legal regulations, industry standards, and ethical guidelines in each field, technique utilization and value creation in a socially accepted and sustainable form are achieved. According to the establishment of such a mechanism, the body expression and the value of motion technique that had previously been dependent on subjective evaluation are recognized/evaluated in a more objective and highly transparent form, thus contributing to the construction of a society achieving rights protection and appropriate reward return of the creator and the performer.

### Outline

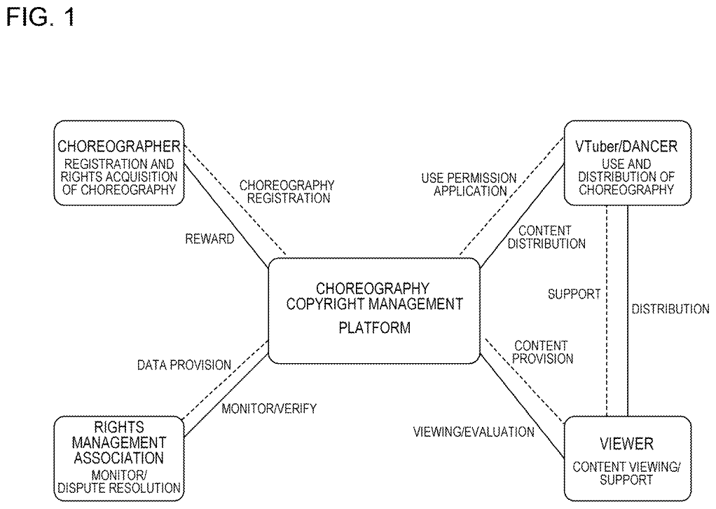

An outline of this example embodiment will be described. FIG. 1 is an overview diagram of an entire system, and illustrates an entire configuration of a choreography copyright management system utilizing a three dimensions (3D) posture estimation technique. At a central part of the drawing, a choreography copyright management platform is disposed, which platform becomes a core of the system. Four main parties are located around the platform. A choreographer is located at the upper left, and is in charge of registration and establishment of rights of choreography. A VTuber and a dancer are arranged at the upper right, and use and distribute choreography. A rights management association is arranged at the lower left, and is in charge of monitoring and dispute resolution. A viewer is located at the lower right, and views and supports content.

In the figure, the data flow between these parties and the platform is represented by a dashed line or a solid line. A solid line indicates data input, and includes, for example, registration of choreography from a choreographer to a platform, application for use permission from a VTuber/dancer, monitoring/verification by a rights management association, viewing/evaluation from a viewer, and the like. A dotted line indicates data output, and includes rewards from the platform to the choreographer, content distribution to the VTuber/dancer, data provision to the rights management association, content provision to the viewer, and the like.

Also illustrated on the right side of the drawing is the direct relationship between the VTuber/dancer and the viewer. A solid line between the VTuber/dancer and the viewer represents distribution, and a dotted line between the viewer and the VTuber/dancer represents support.

With this system, a mechanism for preventing infringement of rights while appropriately managing the copyright of the choreography created by the choreographer and smoothly performing use by the VTuber/dancer is constructed. The choreographer can obtain an appropriate reward while protecting rights by registering the choreography he/she created on the platform. By obtaining the use permission, the VTuber/dancer can properly produce/distribute content by using the choreography. The viewer can enjoy and support the content. The rights management association is responsible for monitoring the entire process and resolving any dispute.

### Device Configuration

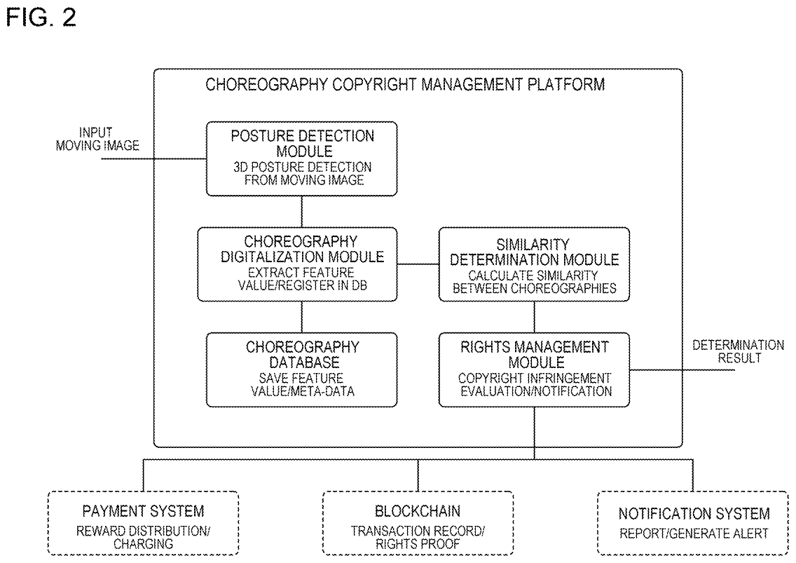

A device configuration of this example embodiment will be described. FIG. 2 is a system architecture diagram, and illustrates main functional configurations of a choreography copyright management system and their relevance. A choreography copyright management platform is located at the center of the drawing, and four main functions and databases are configured in the platform.

A posture detection function (posture detection module) located at the uppermost part has a function of receiving moving image data as an input and detecting three-dimensional posture information of a person. The posture detection function passes the detected posture information to the choreography digitalization function (choreography digitalization module). The choreography digitalization function performs processing of extracting a feature value of a choreography from the input 3D posture data and registering the feature value in the choreography database. The feature value includes at least one piece of information among the relative positional relationship of the body parts, the speed of the movement, the acceleration, and the angular change.

The choreography digitalization function and the similarity determination function (similarity determination module) arranged on the right side thereof exchange data therebetween. The similarity determination function has a function of calculating similarity between the newly input choreography and the choreography registered in the existing choreography database. The similarity determination function acquires, from the choreography database, registered choreography data to be compared with the newly input choreography.

The similarity determination function passes a result of the similarity determination to a rights management function (rights management module) disposed below. The rights management function has a function of evaluating the possibility of copyright infringement based on the calculated similarity, and performing notification and a countermeasure as necessary.

The choreography database arranged at the lower left of the drawing receives and saves the feature value data from the choreography digitalization function. Not only the feature value information but also metadata related to the choreography can be stored in the choreography database.

Three linkage systems are shown in dotted boxes outside the choreography copyright management platform. These are a payment system, a blockchain, and a notification system from the left, and functions such as reward distribution, a transaction record, and alert generation are achieved in cooperation with a rights management function. The rights management function transmits and receives various types of information such as a request for processing based on the evaluation result to and from these external systems.

Furthermore, the figure illustrates a state in which a moving image is input to the posture detection function. This moving image input serves as a processing starting point of the choreography copyright management system. The figure also illustrates a state in which the determination result is output from the rights management function. With this output, the processing result of the choreography copyright management system is notified to the outside.

With this architecture, a series of processing of detecting a 3D posture from a moving image, characterizing and registering choreography, evaluating similarity between choreographies, and managing rights is automated, and copyright protection of choreography and appropriate use permission/reward distribution are achieved. The functions closely cooperate with each other while having a clear role share, and function as an integrated system, thereby contributing to solving the problem of the choreography copyright in the VTuber market and the like.

### Flow of Processing

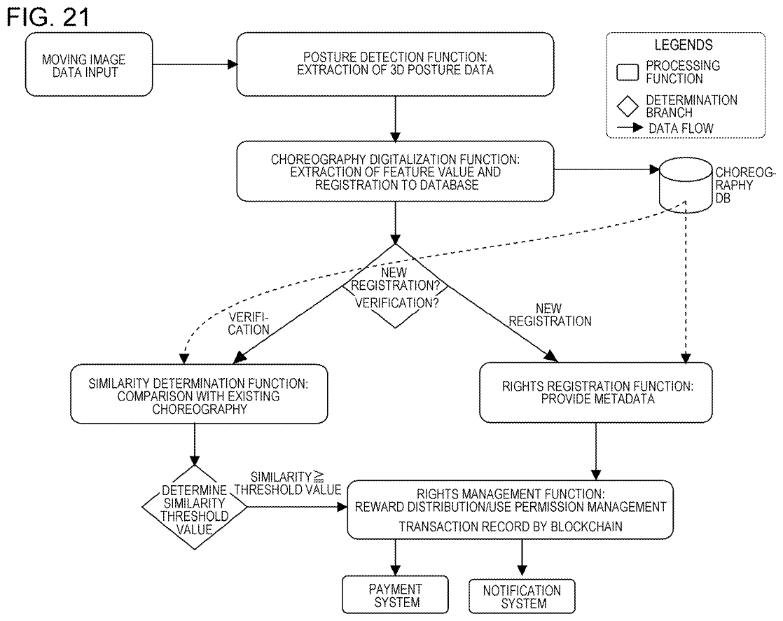

The flow of processing in this example embodiment will be described. FIG. 21 is a diagram illustrating an example of a flow of processing of this example embodiment. In the choreography copyright management system according to this example embodiment, a series of processing from input of moving image data to rights management is systematically executed for the purpose of managing a choreography copyright.

First, moving image data of the choreography is input to the choreography copyright management system as a starting point of the processing. This is used in a case where a choreographer registers original choreography, a case where a user such as a VTuber verifies similarity with the existing choreography, and the like. The input moving image data is sent to the posture detection function, and extraction processing of the three-dimensional posture data is executed. The posture detection function acquires joint movement data of a human body from a moving image by a series of processing such as person detection, skeleton point estimation, three-dimensional posture restoration, and time-series data generation after performing frame division and noise removal as preprocessing. In this process, an image recognition technique and a deep learning model are utilized, and stable posture detection is possible even under various conditions.

The 3D posture data extracted by the posture detection function is passed on to the choreography digitalization function. The choreography digitalization function performs preprocessing such as noise removal and normalization of time-series data, and then extracts a feature value numerically expressing a feature of a choreography. The feature value includes at least one piece of information among the relative positional relationship between the body parts, the velocity vector of the movement, the acceleration vector, and the angular change, whereby the movement of the choreography is quantitatively expressed. The extracted feature value is registered in the choreography database together with metadata (choreographer's name, music information, registration date, etc.) related to the choreography.

After the processing up to the choreography digitalization is completed, the processing flow branches into two paths of “new registration” and “verification”. In the verification path, the similarity determination function calculates the similarity between the input choreography and the choreography registered in the existing choreography database. In the similarity calculation, methods such as Dynamic Time Warping (DTW), detection of partial matching, and weighting for each body part are combined, and similarity evaluation is performed in consideration of temporal deviation, speed difference, partial matching, and the like. On the other hand, in the new registration route, the rights registration function assigns rights related metadata such as copyright information to the choreography data and formally registers the same in the choreography database.

After calculating the similarity, the similarity determination function proceeds to a process of similarity threshold value determination. In this process, the similarity determination function compares the calculated similarity with a preset threshold value, and evaluates a possibility of copyright infringement. In a case where the similarity is equal to or greater than the threshold value, the processing shifts to the rights management function, and notification of copyright infringement or a countermeasure is taken. If the similarity is less than the threshold value, it is determined that the possibility of copyright infringement is low, and new registration can be proceeded. The newly registered choreography is also integrated into the rights management function in cooperation with the rights registration function, and processing such as reward distribution and use permission management is performed.

The rights management function uses blockchain technique to record registration information of choreography safely and transparently, a use history, reward distribution information, and the like. Specifically, a choreography registration transaction, a use permission transaction, a reward distribution transaction, and the like are recorded on the blockchain, and transparency and traceability of the transaction are ensured. In addition, the smart contract function achieves automatic reward distribution, rights transfer, and the like according to use conditions. The rights management function also cooperates with an external system, a reward payment to the choreographer is executed through the payment system, and various notifications are distributed to the rights holder and the user through the notification system.

With such a series of processing flows, all processes necessary for copyright management such as creation, registration, similarity determination, and rights management of choreography are systematically executed. According to the objective choreography digitalization and similarity determination based on the 3D posture estimation technique, management of the choreography copyright, which has been dependent on subjective determination, can be quantitatively and efficiently performed, and a mechanism for promoting appropriate protection and distribution of choreography in the VTuber market is achieved.

The above is an overview of the choreography copyright management system in this example embodiment. Next, each function will be described in detail.

### Details of Posture Detection Function: Concept of Posture Estimation

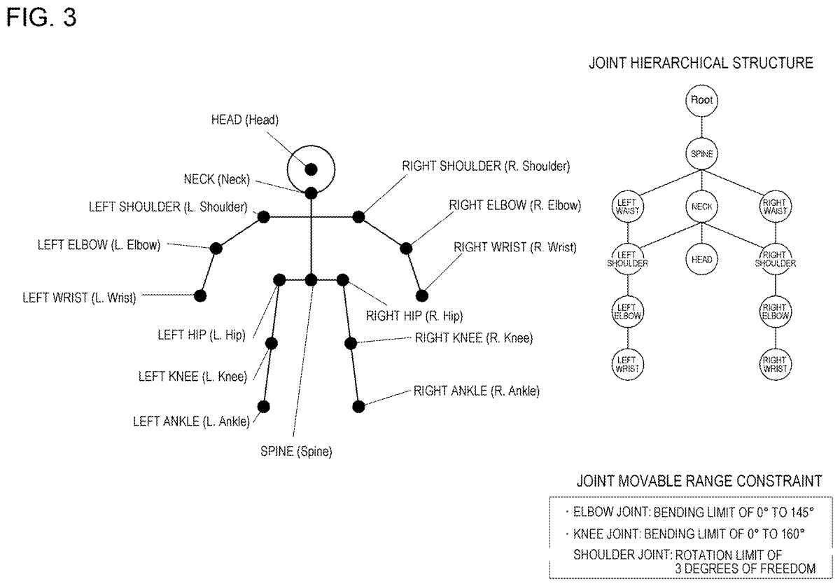

First, a concept of posture estimation in the posture detection function will be described. A 3D model will be described below as an example of the detected posture, but the detection target is not limited to the 3D model. Planar posture detection may be executed. FIG. 3 is a diagram illustrating an example of definitions of skeleton points and joints. In the figure, the skeleton structure of the human body to be detected and analyzed by the posture detection function is clearly shown. A wire frame model of a human body is drawn from the front surface on the left side of the drawing, and a human body structure is represented by main joint points and skeleton lines connecting them.

In this wire frame model, each point indicated by a black circle is a joint point to be detected, and a total of 15 points of the head, the neck, the left and right shoulders, the elbows, the wrists, the spine, the left and right waists, the knees, and the ankles are defined. These joint points are connected by lines to form a skeleton structure of a human body. Each joint point is given an explanatory label associated with a lead line, and relevant names in Japanese and English are described. This clear definition guarantees consistency and compatibility of posture data in three-dimensional or two-dimensional space.

A “joint hierarchical structure” is illustrated at the upper right part of the drawing to represent a parent-child relationship of the skeleton. In this hierarchical structure, with the root (reference point) as a vertex, a central axis continuing to the spine, the neck, and the head and configurations of four limbs branching from the central axis are clearly shown. Specifically, the left and right hips are branched from the spine, each of which continues to the ankle through the knee. In addition, the left and right shoulders are branched from the neck, each of which continues to the wrist through the elbow. This hierarchical relationship is important in the processing of posture data, and defines interlocking property in which the movement of the parent joint affects the child joint. For example, if the spine rotates, all the lower joint points move in conjunction with the rotation.

A “joint movable range constraint” is written at the lower right part of the drawing, and a physical constraint condition for reproducing a natural movement of the human body may be provided. The illustrated numerical values are an example, and this is not the sole case. In the illustrated example, the elbow joint has a bending limit from 0° to 145°, and the characteristic of the human body that the elbow joint does not bend in completely opposite directions is reflected. Similarly, a bending limit of 0° to 160° is set for the knee joint. In addition, the shoulder joint has a rotation limit of three degrees of freedom, and a constraint is provided so as not to be in an anatomically unnatural posture although a complicated movement is possible. These constraint conditions contribute to improvement in accuracy of posture estimation, and prevent estimation of a physically impossible posture.

The posture detection function detects the joint point from a moving image based on these definitions and methods, and estimates the position of each detected joint point in the three-dimensional or two-dimensional space. The estimated position information of the joint points is recorded as time-series data, and becomes the basic data of feature value extraction of the choreography. In addition, by applying the joint hierarchical structure and the movable range constraint, it is possible to restore a natural human body posture from data having noise or a defect. By defining such a detailed skeleton model, it is possible to detect movements of various dances and choreography with high accuracy and quantify them as digital data.

### Method of Processing Posture Detection Function

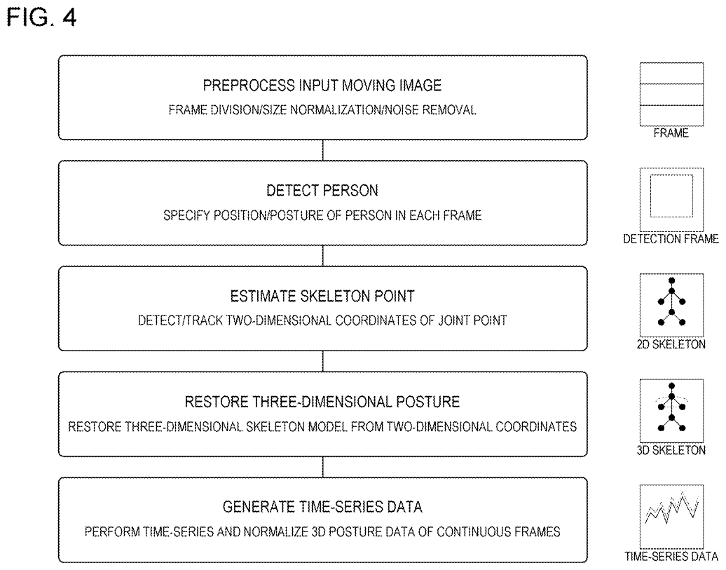

A flow of specific processing of the posture detection function will be described. FIG. 4 is a processing flowchart of 3D posture detection, and illustrates a series of processing processes of detecting a three-dimensional posture from a moving image. This processing includes five main steps, and the processing proceeds in time-series from top to bottom.

First, as a first step, the posture detection function performs preprocessing of the input moving image. In this process, the posture detection function divides the moving image for each frame, and performs processing such as size normalization and noise removal with respect to each frame. As a result, accuracy improvement and stabilization of subsequent processing can be achieved. An example of a preprocessed frame is illustrated on the right side of the drawing, and scanning lines are represented by horizontal lines.

The frame for which the preprocessing has been completed is sent to the person detection that is the second step. Here, the posture detection function performs processing of specifying a position and a rough posture of a person present in each frame. An example of a person detection frame represented by a dotted rectangle is illustrated on the right side of the drawing, and the position of the target person is indicated by the position of the frame.

In a case where the person is detected, the processing proceeds to skeleton point estimation that is a third step. In this process, the posture detection function detects the two-dimensional coordinates of the main joint points such as the head, the neck, the shoulder, the elbow, the wrist, the waist, the knee, and the ankle in the detected person region with high accuracy. The posture detection function also tracks each joint point between consecutive frames. An example of a two-dimensional skeleton represented by black dots and lines is illustrated on the right side of the drawing, and a joint structure of a human body is represented.

The result of the skeleton point estimation is passed to the three-dimensional posture restoration that is the fourth step. In this process, the posture detection function restores the posture in the three-dimensional space from the coordinate information of the joint points detected in two dimensions. For the restoration, a depth estimation algorithm and anatomical constraint conditions of the human body are utilized, and ambiguity in three-dimensional restoration from the two-dimensional information is eliminated. The right side of the drawing shows an example of a three-dimensional skeleton. This step may be skipped in a case where posture estimation in a two-dimensional space is performed.

In a fifth step (final step), the posture detection function generates time-series data. Here, the posture detection function arranges and normalizes three-dimensional posture data obtained from consecutive frames in time-series order. As a result, comparison between different moving images becomes possible, and conversion into a format that can be utilized as basic data of feature value extraction of choreography is performed. An example of time-series data represented by a plurality of polygonal lines is illustrated on the right side of the drawing, and a change in posture parameter with elapse of time is represented.

### Outline of Choreography Digitalization Function

Next, a method of processing skeleton data acquired by posture detection by the choreography digitalization function will be described.

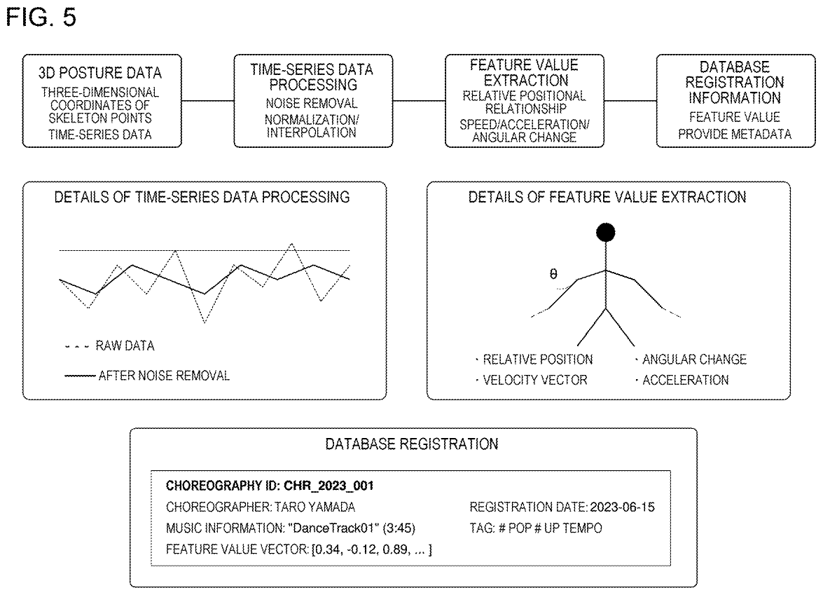

FIG. 5 illustrates a series of processing processes from extraction of the feature value of the choreography from the 3D posture data to registration in the database. This drawing has a configuration in which the flow of processing proceeds from left to right, and includes four main processing blocks and detailed description portions thereof.

The four processing blocks arranged at the upper part of the drawing represent the main steps of the conversion into the choreography data. The first block is “3D posture data”, and the choreography digitalization function acquires three-dimensional coordinates and time-series data of skeleton points output from the posture detection function as input information. This data represents the movement of a person extracted from the moving image as the position information of the joint point in the three-dimensional space.

The next block is “time-series data processing”, and the choreography digitalization function may perform preprocessing such as noise removal, normalization, and interpolation on the input 3D posture data. According to this processing, sensor noise, a detection error, and the like are reduced, and more accurate 3D posture data is generated. Details of this block are shown in the left side of the middle stage of the drawing. Although the raw data represented by the wavy line includes noise and fluctuation, the raw data after processing (after noise removal in the drawing) has a smooth curve as indicated by a solid line. As a result, the essential movement of the choreography is extracted, and it is visually represented that the unnecessary fluctuation is removed.

The third block is “feature value extraction”, and the choreography digitalization function extracts various numerical information (feature value) characterizing the choreography from the processed 3D posture data. Specifically, the choreography digitalization function calculates at least one piece of time-series information among the relative positional relationship between the body parts, the velocity vector of the movement of each joint point, the acceleration vector, and the angular change. Details of this process are shown on the right side of the middle stage of the drawing. A velocity vector is indicated by an alternate long and short dash line on a stick human model, and an angular change is indicated by a broken line. By this feature value extraction, the movement of the choreography is mathematically quantified and converted into a data format that enables objective comparison and analysis.

The last block is “database registration”, and the choreography digitalization function gives metadata regarding choreography to the extracted feature value and registers the feature value in the database. An example of the registration information is illustrated in the lower part of the drawing, and a state in which a feature value vector expressed as a numerical array is stored together with metadata such as a choreography ID (identifier), a choreographer's name, music information, a registration date, and a tag is expressed. As a result, the choreography data is stored in the database in a searchable and comparable format, and is used for subsequent similarity determination and rights management.

As described above, FIG. 5 systematically illustrates the entire process in which the 3D posture data is converted into numerical data objectively expressing the characteristic of the choreography through a series of processing and registered in the database together with the metadata. According to this choreography digitalization process, a basis for enabling similarity determination of choreography, that has been dependent on subjective evaluation and visual comparison, to be performed based on quantitative and objective data analysis is constructed. Each processing step utilizes the latest signal processing technique and machine learning technique, and achieves highly accurate feature value extraction and efficient database management.

### Method of Calculating Feature Value in Choreography Digitalization Function

Here, a method in which the choreography digitalization function calculates the feature value of the posture data from the moving image will be described.

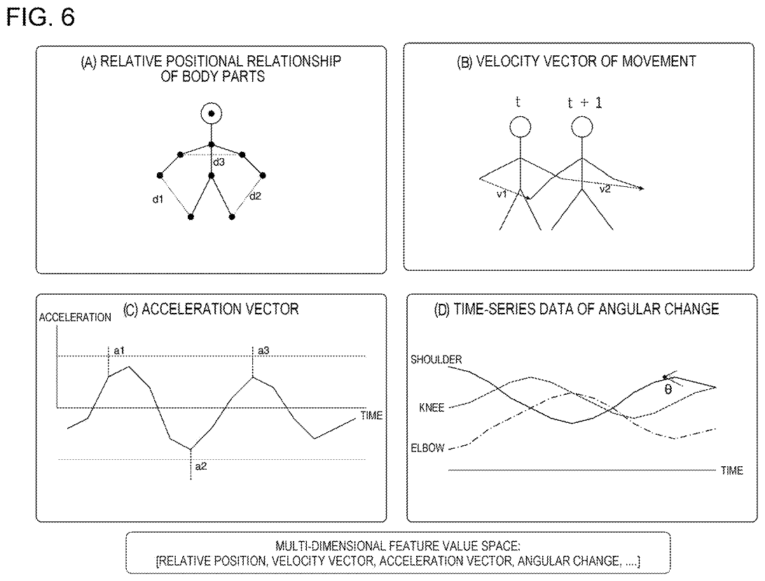

The choreography digitalization function calculates feature values obtained by converting various indexes characterizing choreography into numerical values from skeleton data acquired by the posture detection function. FIGS. 6A to 6D illustrate an expressive method of the choreography feature value, and visually represent four main feature value calculation methods. These feature values capture dynamic characteristics of the choreography in a diversified manner, and provide objective data necessary for subsequent similarity determination.

As illustrated in FIG. 6A, the relative positional relationship between the body parts is an important index that characterizes the posture and shape of the choreography. This feature value is calculated as a distance between the joint points. For example, a plurality of distance parameters are measured, such as the distance between the left hand and the left foot (d1), the distance between the right hand and the right foot (d2), the distance between the left shoulder and the right shoulder (d3), etc. As a calculation formula, a Euclidean distance between two points in a three-dimensional space is used. An example of the calculation formula is as follows.

[Mathematical formula 1]

d=sqrt((x₂−x₁)²+(y₂−y₁)²+(z₂−z₁)²) FORMULA (1)

Since these distance values depend on the size of the skeleton, normalization processing is also applied. As a standard method, the influence of the height difference is eliminated by adopting a relative distance divided by the height of the whole body (distance from the top of the head to the tip of the foot). In addition, since these relative positional relationships change with the elapse of time, they are recorded as time-series data.

FIG. 6B illustrates a method of calculating the velocity vector of the movement. This is derived from the position change of each joint point between successive time frames. In the drawing, the positions of the skeleton at time t and time t+1 are illustrated, and the velocity vector (v1) of the left hand and the velocity vector (v2) of the right hand are represented by arrows. A calculation formula of the velocity vector is as follows.

[Mathematical formula 2]

v=(p(t+1)−p(t))/Δt FORMULA (2)

Here, p(t) is a position vector of a joint point at time t, and Δt is a time interval between frames. This velocity vector has a three-dimensional direction and magnitude, and represents the directionality and momentum of the movement. The magnitude of the speed reflects the energy level of the choreography and the direction characterizes the pattern of movement. In particular, a velocity vector of a terminal region such as a hand or a foot is an important identifier of a choreography style.

FIG. 6C illustrates calculation and representation of the acceleration vector. The acceleration vector is defined as a change rate of speed, and converts the rapidity and smoothness of movement into numerical values. In the drawing, the acceleration vector (a1, a2, a3) at a specific time point is indicated by a dotted line together with the trajectory of the movement along the time axis. A calculation formula of the acceleration vector is as follows.

[Mathematical formula 3]

a=(v(t+1)−v(t))/Δt FORMULA (3)

Here, v(t) is the velocity vector at time t. The sign and magnitude of the acceleration indicate whether the movement is accelerating or decelerating, and the rapidity of the change. For example, a1 and a3 in the drawing are upward acceleration vectors, and indicate that acceleration in an upward direction occurs at that time point. Conversely, a2 is a downward acceleration vector and represents downward acceleration (or upward deceleration).

The acceleration pattern is important in specifying the rhythmic sense of the dance and the emphasized portion of the movement, and is a feature for distinguishing different dance styles. For example, while hip hop is characterized by rapid acceleration changes, ballet often exhibits a smoother acceleration profile.

FIG. 6D expresses the angular change of the joint as time-series data. The temporal change of the bending angle of each joint (elbow, knee, shoulder, etc.) is displayed by different types of lines (solid line, dotted line, alternate long and short dash line). These angular changes indicate the bending degree of the joint and become an important index representing the motion characteristic of the choreography.

The calculation of the angle is defined as an angle formed by two skeleton segments sandwiching the joint. For example, angle θ of the elbow joint is calculated as an angle formed by the vectors of the upper arm and the forearm. An example of the calculation formula is as follows.

[Mathematical formula 4]

θ=across((v₁·v₂)/(|v₁·|v₂|)) FORMULA (4)

Here, v1 and v2 are direction vectors of the upper arm and the forearm, and “·” is a dot product.

The time-series plot in the figure shows how the angle of each joint changes. For example, the elbow joint (alternate long and short dash line) shows a pattern of gently bending first, then extending, and then bending again. These angular change patterns are directly related to specific choreography motions and expressive techniques, and are extremely effective for identifying the style of choreography.

As illustrated at the lowermost part of the figure, the four types of feature values (relative position, velocity vector, acceleration vector, angular change) described above are integrated into a multidimensional feature value space. Specifically, it is represented as a high-dimensional vector in which all the feature values in each time frame are connected.

For example, in the case of a model having 15 skeleton points, feature values of 105 dimensions (the number of combinations of ₁₅C₂) can be extracted from a relative positional relationship, feature values of 45 dimensions (15 points×3 axes) can be extracted from a velocity vector, feature values of 45 dimensions can be extracted from an acceleration vector, and feature values of 30 dimensions (10 joints×3 axes rotation) can be extracted from angular changes of main joints. In a case where these are integrated, a total of a 225-dimensional feature value vector per time frame is obtained.

Furthermore, a statistical property (average, variance, maximum value, minimum value, etc.) and a temporal change pattern (frequency spectrum, autocorrelation, etc.) of these feature values are also calculated for representation of the entire choreography, and are added as feature values. As a result, comprehensive feature representation capturing both the overall characteristics and detailed movement of the choreography is achieved.

These multidimensional feature value data serve as a basis for comparison between the choreographies in the similarity determination function in the subsequent stage, and enable objective and accurate similarity calculation. Furthermore, evaluation of similarity according to the style and purpose of the choreography is also achieved by appropriately weighting each dimension of the feature value.

### Outline of Similarity Determination Function

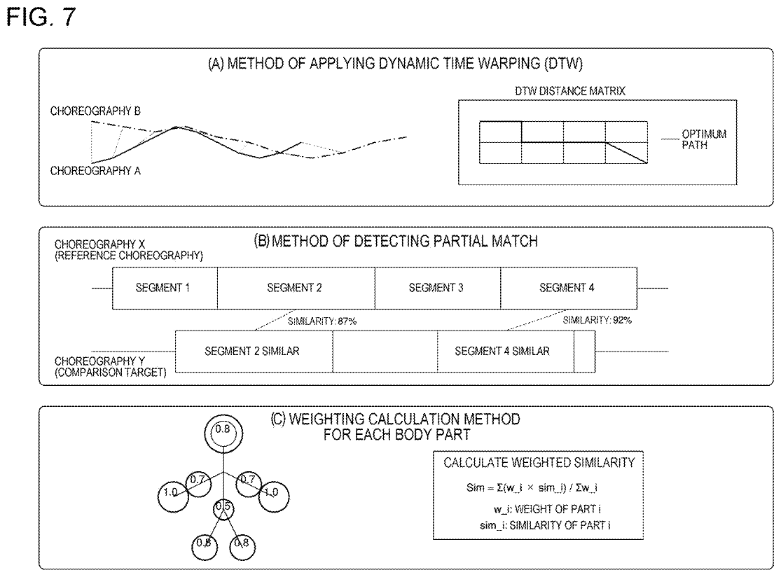

Next, a similarity calculation method performed by the similarity determination function will be described. FIGS. 7A to 7C are overview diagrams of a similarity calculation algorithm, and illustrate three technical approaches as an example for objectively and effectively evaluating the similarity of the choreography. The similarity determination function can calculate the similarity of the feature values described above as the similarity of the choreography. The drawing is divided into three panels (a) to (c) to describe the similarity calculation method from different aspects. The similarity determination function can execute at least one of these processes on a plurality of pieces of choreography data to determine the similarity of the data.

In panel (a), a method of applying dynamic time warping (DTW) is shown. In this panel, two pieces of time-series data, “choreography A” indicated by a solid line and “choreography B” indicated by an alternate long and short dash line, are drawn. These pieces of data have a difference in warping in the time axis direction, and a correspondence relationship is represented by a warping path indicated by a dotted line. According to this method, similarity can be appropriately evaluated even in a case where tempos are different even with the same choreography, or in a case where some movements are fast or slow. A simplified diagram of the DTW distance matrix is illustrated on the right side, and a matrix for calculating the distance between the three pieces of time-series data and an optimal path indicated by a thick line are drawn. This optimum path represents a temporal correspondence relationship in which the similarity is the highest between the two choreographies, and the sum of the distances along this path becomes an index of similarity.

In panel (b), a method of detecting a partial match will be described. In the upper part, “choreography X” serving as a reference is divided into four segments and displayed. In the lower part, “choreography Y” to be compared is illustrated, and it is indicated that there is a portion similar to the segments 2 and 4 of “choreography X”. Segments similar to each other are associated with dotted lines, and similarity (87% and 92%) thereof is also described. According to this method, even if the entire choreography does not match, it is possible to detect a case where a characteristic phrase or a movement pattern is partially diverted. This is an important function for effectively detecting the diversion of the partial choreography that is often seen in actual copyright infringement cases. For example, the similarity determination function can divide a moving image into a plurality of segments by a predetermined method and determine the similarity of movement in units of segments.

In panel (c), a weighting calculation method for each body part is shown. On the left side, a skeleton diagram of a human body is drawn, and the weight of each joint point indicated by a dotted circle is visualized. The size of the circle and the numerical value (0.5 to 1.0) represent the importance of each body part. A part having high visibility and rich expressiveness such as a hand (1.0), a foot (0.8), and a head (0.8) is assigned a high weight, and a part playing an auxiliary role such as a waist (0.5) is assigned a relatively low weight. A mathematical expression of weighted similarity calculation is illustrated on the right side, which indicates that the overall similarity is calculated by a weighted average obtained by multiplying the weight w_i of each part i by the similarity sim_i of each part. This weighting enables similarity evaluation that more accurately reflects the characteristics of the choreography.

In a case where these three techniques are combined, advanced similarity calculation is achieved in consideration of various viewpoints such as temporal warping, partial matching, and difference in importance of a body part. The similarity may be calculated in a range of 0 to 100%, and a possibility of copyright infringement may be evaluated by comparison with a preset threshold value.

### Flow of Processing of Similarity Calculation Method

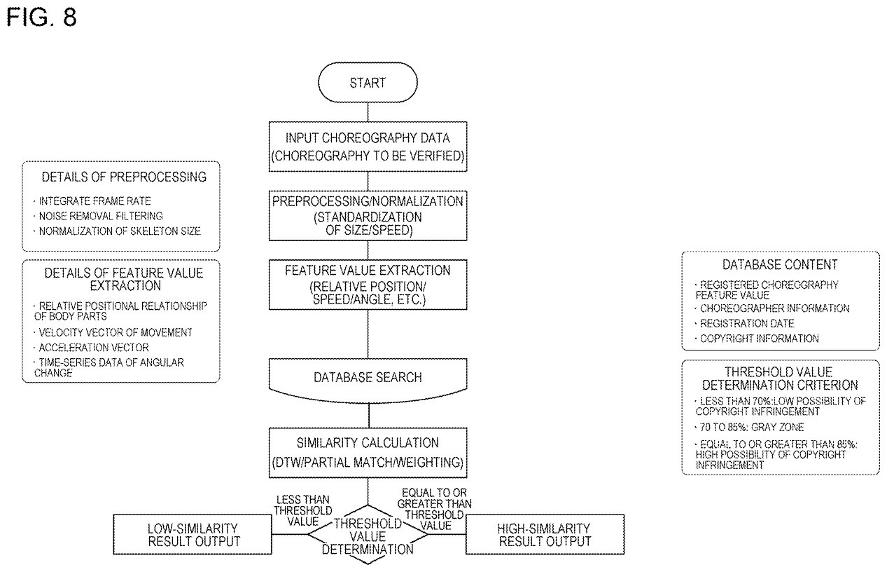

A flow of processing will be described for the similarity calculation method described above. FIG. 8 is a flowchart of a similarity determination process, and illustrates a series of processing processes for evaluating the similarity between the newly input choreography and the choreography registered in the existing database. This flowchart represents from the start of processing to the result output in time-series from top to bottom.

First, the processing starts with a “start” node, and as a first step, the similarity determination function performs a “choreography data input”. Here, the similarity determination function accepts an input of data of new choreography to be verified, and starts processing. Various formats such as 3D posture data and moving image data are assumed as input data, and in any case, appropriate processing is performed in the next step.

Next, the processing proceeds to a “pre-processing/normalization” step, and the similarity determination function applies processing such as frame rate uniformity, noise removal filtering, and skeleton size normalization to the input data. The details of this step are shown as supplementary information on the left side of the figure, and play an important role of translating the data collected under different conditions into a comparable format.

Subsequently, in the “feature value extraction” step, the similarity determination function extracts a feature value from the preprocessed choreography data. As illustrated in the feature value extraction details illustrated on the left side of the drawing, the similarity determination function extracts a relative positional relationship of body parts, a velocity vector of movement, an acceleration vector, time-series data of angular change, and the like. These feature values are obtained by converting essential features of the choreography into numerical values, and serve as a basis for objective similarity evaluation.

In a case where the feature value is extracted, the processing proceeds to a “database search” step. Here, the similarity determination function searches for a comparison target from existing choreography feature values registered in the database. As illustrated in the database content illustrated on the right side of the figure, not only the registered choreography feature value but also choreographer information and registration date/copyright information, and the like are managed, and the information is organized not only from the viewpoint of simple technical comparison but also from the viewpoint of rights management.

In a case where the comparison target is acquired from the database, the processing proceeds to the “similarity calculation” step. Here, the similarity determination function calculates the similarity of the choreography (the similarity of the feature value) using the method described with reference to FIGS. 7A to 7C, such as the dynamic time warping method (DTW), the partial coincidence detection, and the weighting for each body part. As a result, advanced similarity evaluation is performed in consideration of a temporal shift, a difference in speed, a partial matching, and the like.

After the similarity is calculated, the rights management function performs “threshold value determination”. Here, the similarity determination function compares the calculated similarity with a preset threshold value. According to the threshold value determination criteria shown on the right side of the figure, if the similarity is less than 70%, it is determined that the possibility of copyright infringement is low, if the similarity is 70 to 85%, it is determined that the possibility of copyright infringement is a gray zone, and if the similarity is equal to or greater than 85%, it is determined that the possibility of copyright infringement is high.

The processing branches into two according to the determination result, and if the result is less than the threshold value, the processing proceeds to “low similarity result output”, and if the result is equal to or greater than the threshold value, the processing proceeds to “high similarity result output”. The output result includes not only the similarity but also a portion determined to be similar and a distribution of similarity, and is used as a basic material for final determination and rights management by a human.

### Method of Evaluating Possibility of Copyright Infringement by Rights Management Function

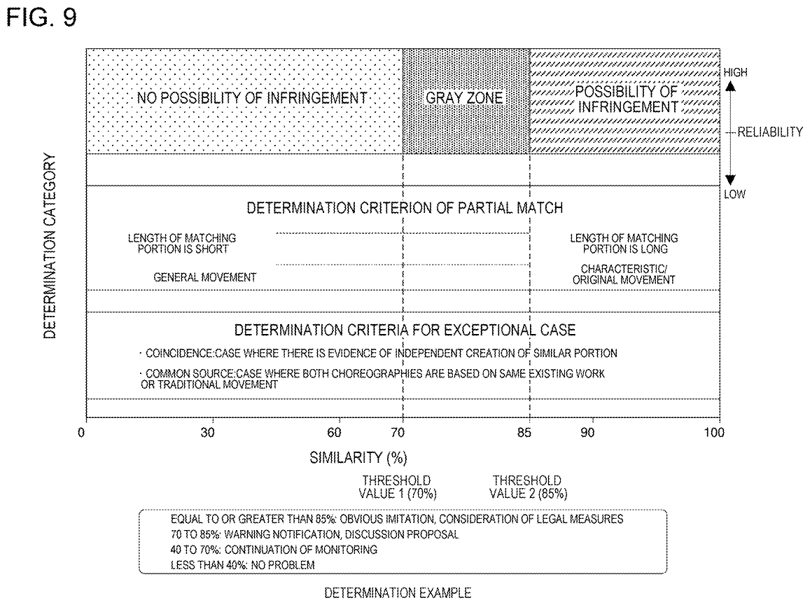

The rights management function evaluates the choreography data based on the similarity described above. FIG. 9 is a determination criterion diagram of the copyright infringement evaluation, and visually represents a criterion for evaluating the possibility of copyright infringement of choreography based on the similarity calculated by the system. In this drawing, similarity (%) is arranged on the horizontal axis, and determination categories are arranged on the vertical axis. The rights management function can evaluate the possibility of copyright infringement based on the illustrated determination criteria.

In the upper region of the drawing, three main determination categories according to the similarity are illustrated. The illustrated numerical values are an example, and this is not the sole case. The range of similarity from 0% to 70% is indicated as “no possibility of infringement”. In this range, the similarity of choreography is low and it is determined that it does not constitute an infringement of a copyright. The range of similarity from 70% to 85% is indicated as a “gray zone”. In this range, the possibility of infringement cannot be denied, and it is determined that detailed verification is necessary. The range of similarity from 85% to 100% is indicated as “possibility of infringement”. In this range, it is evaluated that the possibility of copyright infringement is high.

As an example of important threshold values for dividing these determination categories, 70% and 85% are indicated by dotted lines. These threshold values are important branch points in the similarity evaluation of the choreography, and function as criteria for automatic determination and alert generation of the system. According to the determination example at the lower part of the figure, a similarity of equal to or greater than 85% is regarded as obvious imitation and consideration of a legal measure is recommended, at between 70 and 85%, a warning notification or discussion proposal is appropriate, at between 40 and 70%, continuation of monitoring is recommended, and at less than 40%, it is determined that there is no problem.

An example of a “determination criterion for partial matching” is illustrated at a central part of the figure, and it is described that not only simple similarity but also a length and a feature of movement of a matching portion are considered as determination elements. Specifically, the possibility of infringement increases in the case where the temporal length of the matched portion is longer than in the case where the temporal length of the matched portion is short, and the matching of characteristic/original movement is emphasized rather than general movement. This is based on the idea that a sequence of general movements with a short temporal length may arise from coincidence or limited options of creation, whereas a match of original movements with a long temporal length is likely to have high intentional imitation.

In addition, a special case in which it is not determined as copyright infringement even if a high similarity such as coincidence or similarity due to a common source is detected is described as a “determination criterion for exceptional case” at the lower part of the figure. This relates to a case where there is evidence that similar choreography has been independently created, a case where both choreographies are based on the same existing works or traditional movements, and the like, and the fairness and accuracy of the determination are enhanced by considering these exceptional situations.

An index indicating “reliability” is arranged on the right side of the drawing, and indicates the degree of certainty of the determination. This indicates that not only the similarity score but also factors such as the complexity and length of the choreography and the number of characteristic elements affect the reliability of the determination.

Regarding Blockchain technique as Premise of Reward Management Function

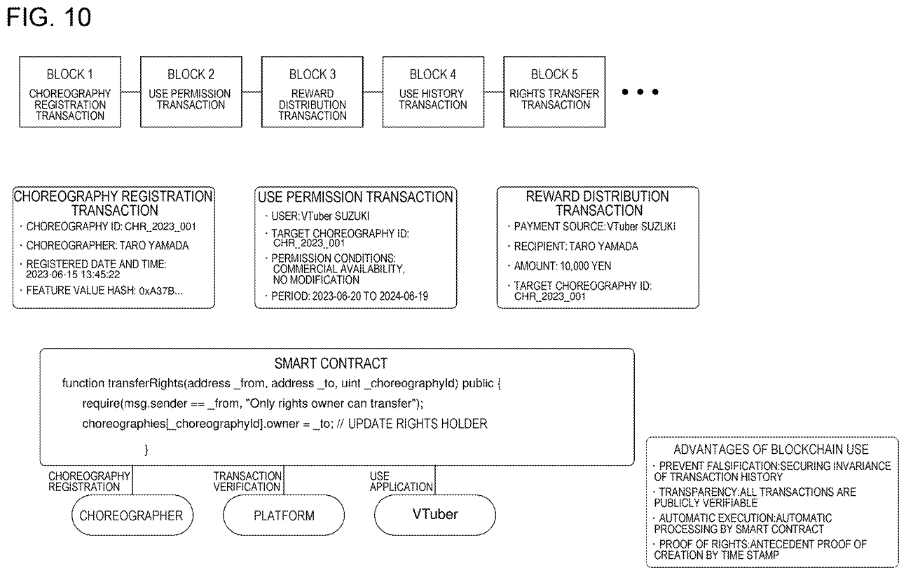

FIG. 10 is a configuration diagram of rights management using a blockchain, and illustrates a system configuration for recording registration information and use history of the choreography safely and transparently. This diagram is largely composed of three elements: a blockchain expression at the top part, transaction details at the center part, and interaction between a smart contract and a party at the lower part.

At the upper part of the drawing, five blocks are drawn in a row, and represent the flow of rights information regarding the choreography. The first block 1 is a “choreography registration transaction” and is generated at the time the creator of the choreography registers his/her work. Block 2 is a “use permission transaction” and is recorded at the time a user such as VTuber acquires the right of use of a specific choreography. Block 3 is a “reward distribution transaction” and includes data at the time a reward for use of the choreography is paid to the rights holder. Block 4 is a “use history transaction” and holds a record of the time and manner in which the choreography was used. Block 5 is a “rights transfer transaction” and is generated in a case where a copyright of a choreography is transferred to another party. These blocks are connected in a chained manner, and information of each block is stored in a form that cannot be falsified.

Details of the three main types of transactions are shown at the center part of the figure. Basic information such as a choreography ID, a name of a choreographer, a registration date and time, and a hash value of a feature value is recorded in the “choreography registration transaction” on the left side. The “use permission transaction” at the center includes terms of agreement related to use such as a user name, a target choreography ID, permission/prohibition of commercial use and modification, and a use period. In the “reward distribution transaction” on the right side, details of the economic transaction such as a payment source, a recipient, an amount, and a target choreography ID are recorded. The transaction data is saved on the blockchain, thereby ensuring transparency and traceability of the transaction.

At the lower part of the figure, a code example of the smart contract is illustrated, and a function for performing rights transfer is described. This code is automatically executed on the blockchain and is designed in such a way that the ownership of the choreography is transferred only if a condition is met. For example, a condition check is included in which only the current rights owner can execute the transfer, and a function of preventing unauthorized transfer of rights is implemented.

Furthermore, at the lower left part of the drawing, a choreographer, a platform, and a VTuber, that are main parties, are illustrated, and how each interacts with the blockchain system in the form of a choreography registration, a transaction verification, and a use application is expressed. At the lower right part, features such as prevention of falsification of a transaction history, ensuring transparency of a transaction, automatic execution by a smart contract, and antecedent proof of creation by a timestamp are listed as “advantages of blockchain use”.

According to the rights management system utilizing such a blockchain technique, copyright information of choreography, which has been managed in a contract or a centralized database, is safely and transparently recorded as a distributed ledger. As a result, an environment in which the user can use the choreography safely while promoting the rights holder's willingness to create is developed, and both appropriate distribution of the choreography in the VTuber market and rights protection are achieved. In addition, efficiency of procedures and cost reduction can be achieved by automation of transactions, and an effect of promoting secondary use and derivative creation of choreography can be expected.

### Details of Reward Management Function: Mechanism of Reward Distribution

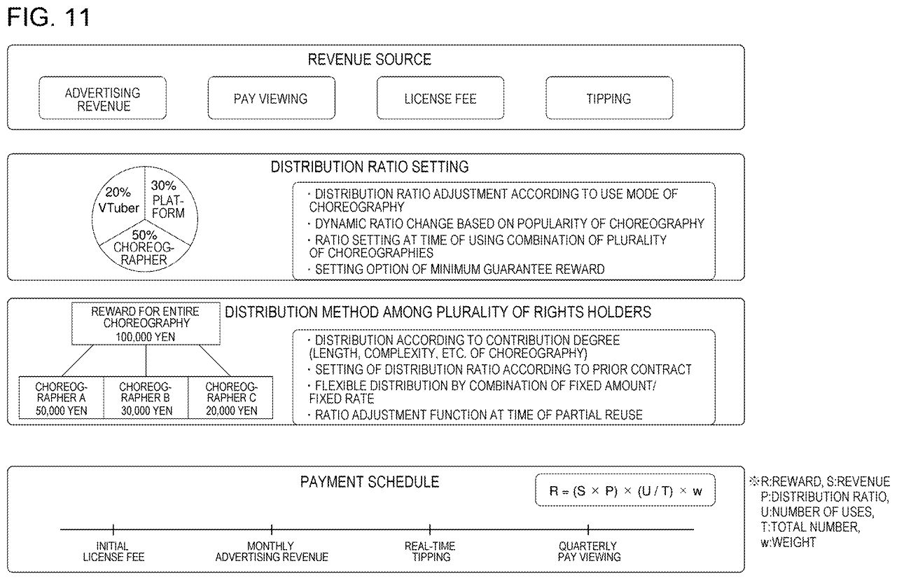

Next, a specific mechanism of reward distribution executed by the reward management function will be described. FIG. 11 is a diagram of a reward distribution mechanism executed by the reward management function, and illustrates a function of automatically distributing a reward according to use of choreography to a choreographer and a mechanism thereof. This figure is composed of four main sections, and systematically represents the flow from the source of revenue to the final payment.

In the “revenue source” section at the uppermost part, various types of revenue generated by the use of choreography are shown. Specifically, four main revenue sources, advertisement revenue, pay viewing, license fee, and tipping are arranged in parallel. The advertisement revenue is a revenue obtained from an advertisement displayed at the time of viewing the content including the choreography, and the pay viewing is a revenue generated from a viewing fee paid by the viewer. The license fee is a fee paid in advance or periodically for the right to use the choreography, and the tipping refers to financial support that the viewer optionally provides to the content producer. These revenue sources are processed by an integrated reward distribution system while being managed separately. The reward management function can acquire information indicating revenue from such a revenue source.

In the following “distribution ratio setting” section, a method of distributing revenue to each party is described in detail. The reward management function calculates the revenue to distribute to each party according to a preset distribution method. The pie chart on the left side shows an example of a standard distribution ratio, in which example, the distribution is 30% for the platform, 50% for the choreographer, and 20% for the VTuber. This distribution ratio is not fixed, but is adjusted by various conditions as described in the panel on the right side. The reward management function may automatically adjust the distribution ratio according to the condition. In addition, the operator may make an input to change the distribution ratio. A ratio adjustment according to a use form of the choreography (commercial/non-commercial use, presence or absence of modification, etc.), a dynamic ratio change according to popularity or the number of times of use of the choreography, a ratio setting in a case where a plurality of choreographies are used in combination, a setting option of a minimum guarantee reward of the choreographer, and the like are also provided. With these flexible settings, a distribution system that is fair and promotes motivation for creation is achieved.

In the third section “distribution method among a plurality of rights holders”, a specific example of reward distribution in a case where a plurality of rights holders are involved in one choreography is illustrated. In the diagram on the left side, a state in which the reward of 100,000 yen for the entire choreography is distributed at a ratio of the choreographer A (50,000 yen), the choreographer B (30,000 yen), and the choreographer C (20,000 yen) is hierarchically expressed. The panel on the right side describes the criteria for determining such a distribution. A distribution according to a contribution degree such as a length and complexity of the choreography, setting of a distribution ratio by a contract signed in advance, a flexible distribution method combining a fixed amount portion and a fixed rate portion, a ratio adjustment function at the time of reuse of partial choreography, and the like are illustrated. As a result, even in a case where a plurality of choreographers create in cooperation, fair reward distribution is achieved.

In the “payment schedule” section at the lowermost part, payment timings of different rewards for each revenue source are shown on a time axis. The initial license fee is paid as a lump sum at the start of use, and the advertisement revenue is counted/distributed monthly. The tipping is immediately distributed in real time, and the revenue from the pay viewing is settled collectively every quarter. A basic formula “R=(S×P)×(U/T)×w” of reward calculation is illustrated in the upper right. It is described that R (reward) is calculated by multiplying a product of S (revenue) and P (distribution rate) by a ratio of U (the number of times of use of the choreography) and T (the total number of all) and further multiplying w (weighting factor). The reward management function can calculate the revenue to be distributed to each of the parties in accordance with the basic formula.

With such a multi-layered reward distribution mechanism, a series of processes of creating, utilizing, and monetizing the choreography is organized, the rights of the choreographer are appropriately protected, and an environment in which content producer such as VTuber can also use the choreography under clear conditions is prepared. In addition, transparency and automatic execution of transactions are secured by operating in cooperation with blockchain technique, and efficiency improvement and reliability improvement of distribution processing are achieved. This reward distribution system functions as an important basis for supporting sound development of the choreography market.

### First Modified Example

The first modified example improves the efficiency of the processing of the posture detection function and the choreography digitalization function described in the first example embodiment, and achieves a configuration for directly extracting a feature value from an input moving image by utilizing a deep learning model and performing similarity determination.

In the first example embodiment, the feature value is extracted through two-stage processing of detecting the 3D posture from the moving image and then converting the 3D posture into the choreography data. On the other hand, in the first modified example, a method of directly extracting a feature value from an input moving image using an advanced deep learning model such as an Auto Encoder (AE), a Variational Auto Encoder (VAE), and a Contrastive Language Image Pretraining (CLIP) model is adopted. According to this method, the efficiency of processing and the sophistication of feature representation are achieved.

Specifically, the system of the first modified example is roughly divided into three main components. The three main components are an “encoder network”, a “feature space processing”, and a “similarity calculation module”.

An “encoder network” directly processes an input moving image and converts it into a low-dimensional feature vector. Three types of approaches are implemented in this network. The first is an approach using an auto encoder (AE), which efficiently compresses a time-series of moving image frames to extract essential movement features. The second is an approach using a variational autoencoder (VAE), which generates a probabilistic latent expression to be able to express variability and uncertainty of choreography. The third approach is an approach in which the CLIP model is applied, which maps the visual features and linguistic descriptions of the choreography (examples: “energetic movement”, “flowing choreography”, etc.) into a common feature space. This makes it possible to cope with a language-based query in a later search or classification task.

In the “feature space processing”, processing such as normalization, dimension reduction, and clustering is performed on the feature vector output from the encoder network. In particular, by applying dimension reduction techniques such as Principal Component Analysis (PCA) and t-Stochastic Neighbor Embedding (t-SNE), a high-dimensional feature vector is converted into a low-dimensional expression that is easier to handle. In addition, a function of automatically grouping similar choreography patterns by a Self Organizing Map (SOM) or k-means clustering is also implemented. By these pieces of processing, it is possible to efficiently organize and visualize a large amount of a choreography data.

The “similarity calculation module” calculates a distance and a similarity between the processed feature vectors. Here, a plurality of distance indices such as Euclidean distance, cosine similarity, and Mahalanobis distance are implemented, and an optimum index can be selected according to the nature of the choreography and the purpose of comparison. In addition, by introducing an Attention Mechanism, it is also possible to calculate similarity with a weight given to a specific part or time section of the choreography. As a result, comparison focusing not only on the entire choreography but also on a characteristic phrase and a movement sequence is achieved.

The model of the first modified example is trained by a combination of supervised learning and unsupervised learning using a large-scale choreography data set. In supervised learning, accuracy and consistency of feature extraction are improved using data pairs in which different versions and similarities of the same choreography are annotated by human experts. In unsupervised learning, learning is advanced such that feature representations of similar choreography are close to each other and expressions of different choreographies are separated using a method such as Contrastive Learning or Triplet Loss.

In addition, transformer-based architectures have also been adopted for feature extraction in view of temporal context. As a result, it is possible to represent features in which a temporal dependence relationship and a long-range interaction in the choreography are appropriately captured.

### Second Modified Example

### Outline

First, an outline of the second modified example will be described. In the first example embodiment, the basic configuration of the choreography copyright management system using the posture estimation technique has been described, but a modified example for coping with more various needs and situations is conceivable in actual operation.

In particular, there are many cases where a plurality of choreographers cooperate to produce one work at a choreography creation site. It is important to clarify the rights relationship in such joint creation and to expand the function for appropriate management. The choreography serving as a joint work has a characteristic that it is difficult to individually use the contribution of each creator, and there is a specific problem in the rights management.

Therefore, the first example embodiment may include a joint copyright management function as a modified example. This achieves spatial/temporal division of rights in one choreography work, management of overlapping rights among a plurality of rights holders, and systematization of a decision-making process regarding use permission. Specifically, a function is provided that divides the choreography into sections along a time axis and clarifies the attribution of rights of each section. In addition, an interface that visualizes the rights distribution according to the contribution degree and the role of a plurality of choreographers, a mechanism that can flexibly set a plurality of decision-making methods such as consensus of all members, majority decision, and representative decision at the time of use permission, and the like are provided.

### Concept of Joint Copyright Management

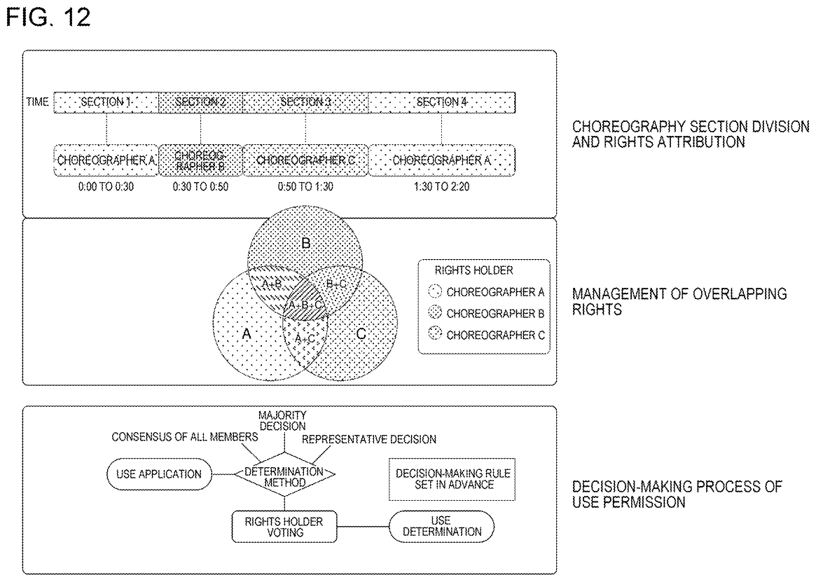

First, a concept of the joint copyright management function will be described. FIG. 12 is a conceptual diagram of joint copyright management, and systematically illustrates a rights relationship and a management method in a choreography work created by a plurality of choreographers in cooperation. This figure is composed of three main sections, and represents management functions from different aspects of spatial division of joint copyright, overlapping relationship of rights, and decision-making process of use permission.

In the “choreography section division and rights attribution” section at the upper most part, at state in which one choreography work is divided into a plurality of sections along a temporal flow, and the rights attribution of each section is clarified is illustrated. Specifically, four sections are drawn along the time axis. Section 1 (0:00 to 0:30) and last section 4 (1:30 to 2:20) are expressed as a work of choreographer A, section 2 (0:30 to 0:50) is expressed as a work of choreographer B, and section 3 (0:50 to 1:30) is expressed as a work of choreographer C. It has been shown that this section dividing allows the rights to a specific part therein to be clearly defined and managed, even in one continuous choreography work. This enables partial use permission and reward distribution.

In “management of overlapping rights” section at the center, rights relationships between choreographers are visualized using Venn diagrams. Each of the three circles represents the scope of rights of the choreographers A, B, and C, and indicates a structure in which these partially overlap to generate a region having joint rights. Specifically, an overlapping region between the two sides such as “A+B”, “B+C”, and “A+C” and a region in which all the three sides share rights such as “A+B+C” at the center are expressed. This overlapping structure occurs, for example, in a case where a plurality of choreographers contribute to the same section in different roles (motion design, rhythm configuration, expression instruction, etc.) or in a case where a plurality of choreographers jointly creates one movement sequence. The legend on the right side shows the area related to each choreographer to help visual understanding of rights relationships.

In the “decision-making process of use permission” section at the lower part, a workflow of how use permission for choreography with joint copyright is determined is illustrated. The process starts with “use application” and is divided into three different decision-making methods at a branch point of “determination method”. “Consensus of all members” represents a strict manner requiring the consent of all involved choreographers, “majority decision” represents a democratic manner determined by majority consent, and “representative decision” represents an efficient manner in which a previously designated representative has authority to determine. Then, the flow is shown through the process of “rights holder voting” to the final “use decision”. On the right side, there is supplementary information “decision-making rules set in advance”, which suggests the importance of an agreement on a determination method being made at the starting time point of the joint production of choreography.

### Specific Implementation Method of Joint Copyright Management

The above-described functions are achieved by cooperation of the functions described so far. Specifically, the posture detection function may be extended to be able to identify a part in charge and a contribution part of each choreographer at the time of processing moving image data of jointly created choreography. For example, the posture detection function may assign a time stamp or marker information to each choreographer in such a way that the attribution of rights can be temporally/spatially divided even within the same choreography. As an example, the posture detection function records, as time metadata, that a specific section (0:00 to 0:30) in a certain choreography is a creation of the choreographer A, and another section (0:30 to 0:50) is a creation of the choreographer B.

The choreography digitalization function may have a function of processing information regarding the joint work as additional metadata in the process of converting the detected posture data into the feature value. In the function, a contribution degree and role information of each choreographer are associated with the feature value data of the choreography, and contributions of a plurality of creators are recorded in a distinguished manner. For example, in the choreography digitalization function, a detailed division of roles such as the choreographer A being in charge of motion design and the choreographer B being in charge of rhythm configuration in the same section is converted into numerical values and stored in a database. In addition, by recording the contribution ratio of each choreographer as a weighting parameter, the choreography digitalization function can also use it as basic data of subsequent reward distribution.

The similarity determination function may individually analyze the contribution portion of each choreographer in evaluating the similarity of the joint work. With this function, for example, in a case where the newly input choreography is similar to the existing joint work choreography, it is possible to specify which choreographer's creation portion is particularly similar. This is effective for the detection of partial rights infringement, and the similarity for each section of the choreography or for each expression element is calculated individually to clarify which rights holder's copyright may be violated.

The rights management function first maintains a database that manages rights distribution among a plurality of choreographers, and records weighting of rights according to the contribution degree and role of each choreographer. The rights management function also has a function of automating a decision-making process in a case where there is an application for use permission, and efficiently processes notification to related choreographers, collection of approvals, and confirmation of a final decision based on a determination method (consensus of all members, majority decision, representative decision, etc.) set in advance. Furthermore, the rights management function automatically calculates the reward distribution in a case where the use is permitted according to the recorded contribution degree and the contract content, and executes appropriate distribution to each choreographer.

### Second Example Embodiment

### Background and Outline

This example embodiment utilizes the 3D posture estimation technique and the infrastructure of the copyright management system described in the first example embodiment to provide more practical and user-oriented functions. While the first example embodiment mainly established a fundamental mechanism of feature value extraction and rights management of the choreography, this example embodiment focuses on application functions that integrate these techniques into the actual user experience and provide value to both content producers and viewers.

Specifically, a learning support function of the choreography data, an effective reflection method of the choreography data on the VTuber, and a choreography analysis/visualization function are provided. These functions technically support the process of efficiently applying the movements created by the choreographer to digital characters such as VTuber and delivering them as attractive performances to viewers.

### Flow of Processing

The flow of processing in this example embodiment will be described. While the first example embodiment focuses on the rights management of the choreography, in this example embodiment, end-to-end processing focusing on utilization and learning support of the choreography data is achieved.

First, description will be made from an input stage of the choreography data. There are roughly two types of input sources. The first is acquisition of the existing choreography data from the choreography database described in the first example embodiment, and the second is direct input from moving image data or 3D motion capture data of the newly created choreography. These input data are processed by a posture detection function and converted into standardized 3D posture data.

Subsequently, the converted posture data branches into three main processing paths according to the application. The first path is a “VTuber application path” and the computer performs mapping processing and optimization to apply the posture data to the 3D model of the VTuber. Here, the computer performs adjustment of the skeleton ratio, motion adjustment according to the movement characteristics, expression enhancement utilizing the personality of the character, and the like, and finally reflects them in the rig of the VTuber model. As a result, the VTuber character can naturally and attractively express the choreography created by the human choreographer.

The second path is a “learning support path”, and the computer generates support information for the learner based on the analysis of the choreography data. In this process, the computer executes difficulty level evaluation of the choreography, segment division for gradual learning, point extraction for improving practice efficiency, and the like. The computer visualizes the analysis result as feedback for learners, and outputs the analysis result as a material for supporting efficient learning of choreography.

The third path is an “analysis/search path”, and the computer performs value measurement and generation of a search index based on the feature value analysis of the choreography data. In this processing, the computer arranges the characteristics of the choreography on the vector space, and performs clustering of choreographies having similar characteristics and mapping between languages and motions for enabling search in a natural language. As a result, the user can search for the choreography required by intuitive words and objectively evaluate the market value of the choreography.

These three processing paths proceed in parallel, but may share information with each other as necessary. For example, the optimization parameter obtained in the VTuber application process is used for learning support, or the analysis result is used for improving the application accuracy to the VTuber.

The output of each processing path is provided through an interface for each end user. The output of the VTuber application path is distributed to the viewer as VTuber performance, and the output of the learning support path is presented as teaching material or feedback for the learner. The output of the analysis/search path is provided to the content producer and the rights manager in the form of a choreography marketplace, an analysis dashboard, or the like.

As described above, in the present example embodiment, a flow for consistently processing from the input of the choreography data to the output for various users is constructed, and an ecosystem of practical use and value creation of the choreography data is achieved on the rights management basis established in the first example embodiment. The latest machine learning technique and 3D graphics technique are applied to each processing step, enabling high-quality and efficient content production and learning support.

### Details of VTuber Application Function

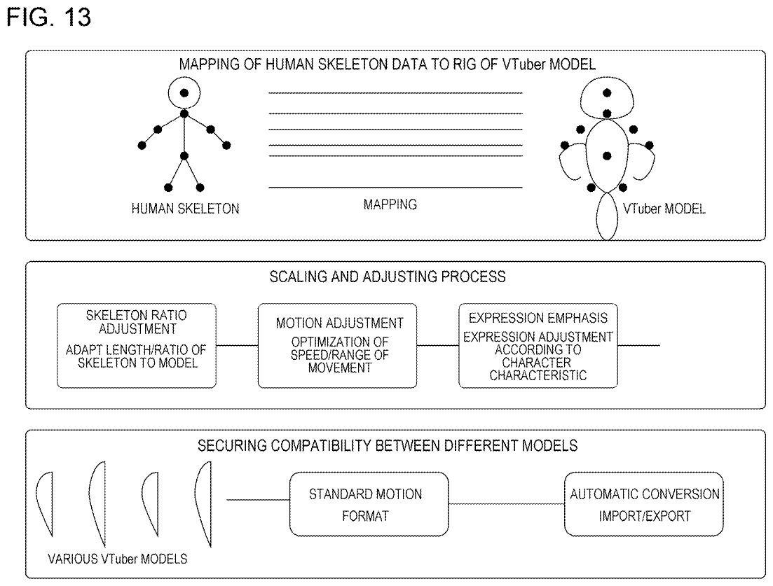

As the VTuber application function, a reproduction method will be described using the choreography obtained from the skeleton data as a 3D model of the Vtuber. FIG. 13 is an application diagram of the choreography data to the VTuber avatar, and illustrates a technical mechanism and a flow of processing for effectively applying the choreography data extracted from the human skeleton to the 3D model of the VTuber. This figure is composed of three main sections, and represents a method for achieving natural reproduction of the choreography by stepwise processing of mapping, adjusting process, and securing compatibility.

In the “mapping of human skeleton data to rig of VTuber model” section at the uppermost part, the correspondence relationship between the human skeleton structure and the rig of the VTuber model (skeleton structure) is shown. On the left side, a human skeleton is drawn with black lines and dots, and main joint points such as a head, a shoulder, an elbow, a wrist, a waist, a knee, and an ankle are clearly indicated. On the right, the rig points indicated by black dots are arranged in the VTuber model. A mapping relationship by a horizontal line is illustrated between the two, and how each joint point of a human is converted to a related place of the VTuber model is expressed. With this mapping, the VTuber application function can regard the movement of the choreographer as time-series motion data of the joint points in the 3D space and apply it to the related part of the VTuber model.

In the “scaling and adjusting process” section at the center, a three-stage processing process for optimizing the mapped basic data to the characteristics of the VTuber model is shown. First, in “skeleton ratio adjustment”, the VTuber application function performs processing of adapting the length and ratio of the skeleton in order to absorb the body shape difference between a human and a VTuber character. In the next “motion adjustment”, the VTuber application function optimizes the speed and movable range of movement in accordance with the physical constraints and expression characteristics of the VTuber model. In the last “expression emphasis”, the VTuber application function performs adjustment such as emphasizing a specific motion or adding a character specific gesture in order to bring out the personality and charm of the character. By these three-stage processing, reproduction of a natural and attractive movement utilizing the characteristics of the VTuber character is achieved instead of mere copy of the motion.

In the “securing compatibility between different models” section at the lowermost part, a mechanism for sharing/utilizing the choreography data among various VTuber models is shown. On the left side, silhouettes of a plurality of VTuber models having different shapes and proportions are drawn, representing the presence of various character designs. A common data format “standard motion format” is located in the middle, and an “automatic conversion import/export” function is shown on the right. With these mechanisms, the VTuber application function can mutually convert the choreography data created once between different models and automatically apply adjustment in accordance with model-specific characteristics. By securing compatibility, reusability of the choreography data is enhanced, and efficient content production is achieved.

Such a technical conversion/optimization process allows the VTuber 3D avatar to naturally and attractively reproduce the richly expressive choreography created by the choreographer. In addition, securing compatibility by the standard format facilitates sharing and reuse of choreography among various VTuber characters, and creation of various expressions and expansion of content are promoted. These technological bases are important elements supporting quality improvement of dance performance and efficient production in the VTuber market.

### Details of Learning Support Function

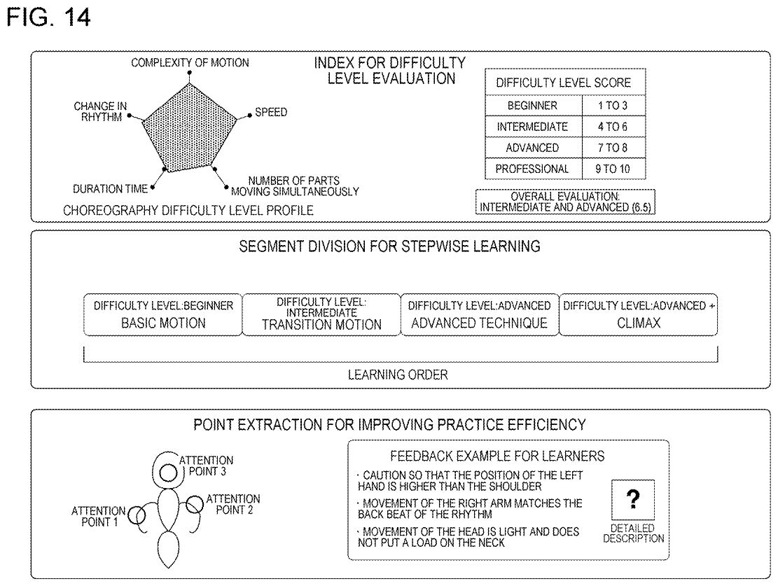

Next, the learning support function will be described. FIG. 14 is a diagram illustrating the provision of the choreography analysis and the learning support information, and illustrates a function in which this system analyzes characteristics and difficulty level of the choreography from multiple viewpoints and provides appropriate support information to the learner. This drawing is composed of three main sections, and systematically expresses the learning support function from the viewpoint of difficulty level evaluation, segment division for stepwise learning, and point extraction for improving practice efficiency.

As illustrated in the “index for difficulty level evaluation” section at the uppermost part, the learning support function objectively and multidimensionally evaluates the difficulty level of the choreography. The learning support function can generate information as illustrated and output the information toward the user. A pentagonal radar chart is drawn on the left side, and a difficulty level profile of choreography is visualized based on five evaluation axes of “complexity of motion”, “speed”, “number of parts moving simultaneously”, “duration time”, and “change in rhythm”. Hereinafter, an example of an evaluation method of each of the five evaluation axes will be described.

The learning support function calculates the “complexity of motion” based on a plurality of evaluation axes in order to objectively evaluate the difficulty level of the choreography. Specifically, the learning support function first analyzes the time-series data of each joint point included in the skeleton data acquired by the posture detection function, and integrally evaluates the following elements.
(1) Change pattern of relative positional relationship between body parts
(2) Swing width of angular change of each joint
(3) Number of types of continuous posture transition in entire motion

For example, the learning support function determines that the complexity of the motion is higher as the number of sections in which the angular change of the joint greatly swings is larger, and as the plurality of body parts frequently repeat movements in different patterns in conjunction with each other. Furthermore, the learning support function may perform autocorrelation analysis of the motion trajectory, and set the complexity score higher the lower the similarity of the shape patterns between consecutive frames (that is, as new posture patterns appear one after another). In the learning support function, such analysis results are integrated to convert the complexity of the motion into numerical values, and they are reflected on the model as an index in which the difficulty level becomes higher the higher the numerical value.

Furthermore, the learning support function may calculate speed data and acceleration data of the body part and evaluate the difficulty level using “speed” as an index. Specifically, the learning support function first extracts the velocity vector of each joint point from the time-series data, and obtains the average speed and the maximum speed as statistics. Furthermore, by analyzing the steepness of the change rate (acceleration) of the velocity vector, the learning support function can determine that the difficulty level is higher the more the intensive movement continues. For example, in the learning support function, as a large speed change occurs in a part having a relatively high degree of freedom such as a terminal part (wrist or ankle) of a limb, a burden of accurate reproduction increases for the learner, and thus a difficulty score can be added. In addition, the learning support function can estimate that advanced physical/technical skills are required the more the scene in which the high speed continues for a certain period of time as a whole, and the difficulty level can be increased accordingly.

Furthermore, the learning support function may evaluate the “number of parts moving simultaneously” and the “change in rhythm” in consideration of the number of body parts moving simultaneously and the “duration time” that must be maintained for a certain period of time. Specifically, the learning support function counts the total number of joint points determined to be moving in a frame, and obtains an average value and a maximum value thereof as the number of parts that move simultaneously. Then, the learning support function can have a higher difficulty level as the number of parts that move at the same time increases. In addition, the learning support function can analyze the number of changes in the motion timing in accordance with the time of music or a Beats Per Minute (BPM), and can determine that the difficulty level is higher the more frequently the rhythm is switched. Furthermore, in a case where there are switches of a plurality of different rhythm patterns and rests in the choreography, the learning support function can increase the difficulty level assuming that the burden at the time the learner adjusts the motion and the music increases. For example, a section in which the tempo changes suddenly and a section in which irregular beats that are difficult to count are frequently used are calculated with high evaluation in the change in rhythm. As described above, the learning support function comprehensively estimates the entire choreography difficulty level by integrally analyzing the duration time of the motion and the complicated rhythm pattern.

Then, from the area and shape of the polygon of the radar chart in the drawing, it can be understood that this choreography has a relatively high difficulty level in speed and complexity. On the right side, a correspondence table of difficulty level scores is arranged, and four-grade evaluation criteria of beginner (1 to 3), intermediate (4 to 6), advanced (7 to 8), and professional (9 to 10) are shown. In this example, “overall evaluation: intermediate and advanced (6.5)” is determined, and it can be seen that the choreography is positioned in the transition stage from the intermediate to the advanced. By such quantitative difficulty level evaluation, the learner can select the choreography suitable for his/her skill level.

In the “segment division for stepwise learning” section at the center, the learning support function divides the choreography according to the difficulty level and provides a method for learning in a stepwise manner. The learning support function can generate information as illustrated and output the information toward the user. The choreography is divided into four segments along a time axis extending in the horizontal direction, and the difficulty level is increased in a stepwise manner from the left as “basic motion (beginner)”, “transition motion (intermediate)”, “advanced technique (advanced)”, and “climax (advanced +)”. In each segment, a difference in difficulty level may be expressed by color depth. The learner can efficiently learn the entire choreography by learning the segments in ascending order of difficulty level. In addition, the order of progress of learning may be indicated by an arrow or the like, and a learning path that proceeds in a stepwise manner from the basic to application may be clearly indicated. This divided approach supports even complicated choreography to be easily learned.

In the “point extraction for improving practice efficiency” section at the lower part, the learning support function extracts particularly important technical points from the choreography, and presents an effective practice method. The learning support function can generate information as illustrated and output the information toward the user. A silhouette of a person is drawn on the left side, and an “attention point” surrounded by three dotted circles is emphasized. These represent body parts and movements that require particular attention in the choreography, and visually indicate points to focus on for efficient practice. In the “feedback example for learners” on the right side, detailed instruction contents such as “caution so that the position of the left hand is higher than the shoulder”, “movement of the right arm matches the back beat of the rhythm”, and “movement of the head is light and does not put a load on the neck” are described as specific advice. Furthermore, “?” mark icon at the lower right indicates a link to detailed explanation, indicating that supplementary information for deeper understanding can be accessed.

The learning support function can analyze time-series skeleton data (position, speed, acceleration, joint angle, etc.) acquired by the posture detection function or the choreography digitalization function, and extract important technical points in the following steps.

(1) Analysis of joint behavior: The learning support function refers to each frame of the skeleton data, focuses on the main joints such as the shoulder/elbow/knee/ankle, and calculates each motion amount and angular change amount. The learning support function evaluates a swing width of a velocity vector and an angular change of a joint, and extracts a part that rapidly moves in a short time or a part that is difficult to maintain a posture as a candidate.

(2) Evaluation of synchronization degree with rhythm and music: The learning support function compares motion timing of each frame with captured music information (BPM, time, etc.), and converts a degree of deviation from rhythm into numerical values. The learning support function treats a part having a large deviation or a part sensitive to a change in tempo as an “important place of motion” and adds it to the extraction candidate.

(3) Comparison with posture reference: The learning support function compares with “ideal posture” or “typical movement reference data” registered in advance, and detects a part greatly deviating from the reference. For example, the learning support function grasps, as a numerical value, a case where the angle is not sufficient although the motion of raising high is necessary, a case where the direction of turning is different from the ideal posture, or the like, and marks it as an important part.

(4) Prioritization of evaluation values: The learning support function integrates the information obtained in the above (1) to (3), and obtains a total score from the difficulty level of the motion, the characteristics of the choreography, the degree of synchronization with the rhythm, and the like. The learning support function treats a higher score as a higher importance technical point, and visually emphasizes it as an “attention point” on the screen.

(5) History analysis (arbitrary extended function) for individual user: In a case where the learning support function accumulates past practice histories or a weakness tendency of each user (lack of specific angle, easy deviation from rhythm, etc.), the learning support function weights the extraction result with priority with reference to the history. As a result, points that should be particularly noted by individual learners can be automatically corrected/added and presented.

In addition, the learning support function can generate specific advice for the technical points extracted/analyzed in the above manner by the following procedure and present the advice to the user.

(1) Calculation of shortage/excess by motion comparison: The learning support function compares an ideal value (examples: shoulder angle, back stretch, arm trajectory, etc.) with an actual measurement value for the extracted point, and converts the difference into numerical values. For example, the learning support function grasps a quantitative difference such as “the shoulder angle is less than the ideal by 10°” or “the bending angle of the knee is larger by 5°”.

(2) Determination of an appropriate modifying direction: The learning support function determines a direction of how to modify based on the content of the difference. The learning support function generates an advice candidate by associating a body part with an action such as “further raise the shoulder” if the angle is insufficient and “swing the arm a little faster” if the speed is slow.

(3) Verification of learner level and intention: The learning support function checks conformity with a level (such as beginner/intermediate/advanced) set in advance by the user and a target (performance emphasis/reduction of burden on the body/improvement of the number of times, etc.), and adjusts the strength and expression of the advice as necessary. For example, the learning support function presents a more quantitative and detailed instruction in soft wording such as “widen the movable range little by little without straining oneself” for the beginner, and “stretch your elbows by 5° more and adjust the timing to the end of the song” for the advanced-level person.

(4) Text conversion by expression generation rule: An advice sentence that can be naturally read as a text is created based on the modifying direction determined in (2) and (3) and the learner information. The learning support function automatically constructs a sentence such as “Raise your shoulder a little more to keep a straight line from the head to the fingertip” using a fixed phrase template and a generation model prepared in advance.

(5) Creation of visual supplementary information: The learning support function may generate a visual guide using a posture diagram, an arrow, or the like in addition to a sentence-based advice. For example, the learning support function can help the user's understanding by emphasizing the related part with a red frame and showing supplementary explanation such as “raising a hand to here” with a simple animation or an enlarged view.

(6) Accumulation and update of feedback: The learning support function can re-acquire and accumulate results in the system each time the learner executes an advice. If an improvement is found, the learning support function can perform dynamic update such as excluding the element from the subsequent advice or lowering the priority.

With such a multi-layered learning support function, the learner can make an appropriate learning strategy according to his/her level and purpose. The system automatically analyzes the structure and features of the choreography and provides optimized information to individual learners to support efficient and effective learning. In addition, these pieces of analysis information can also be used, as a reference, as an objective evaluation of created choreography for the choreographer, and can also be used for development of educational choreography, difficulty level adjustment, and the like. As described above, this function is an important element contributing to the development of the ecosystem from both the spread of choreography in the VTuber market and the improvement of technique.

### Details of Analysis Function

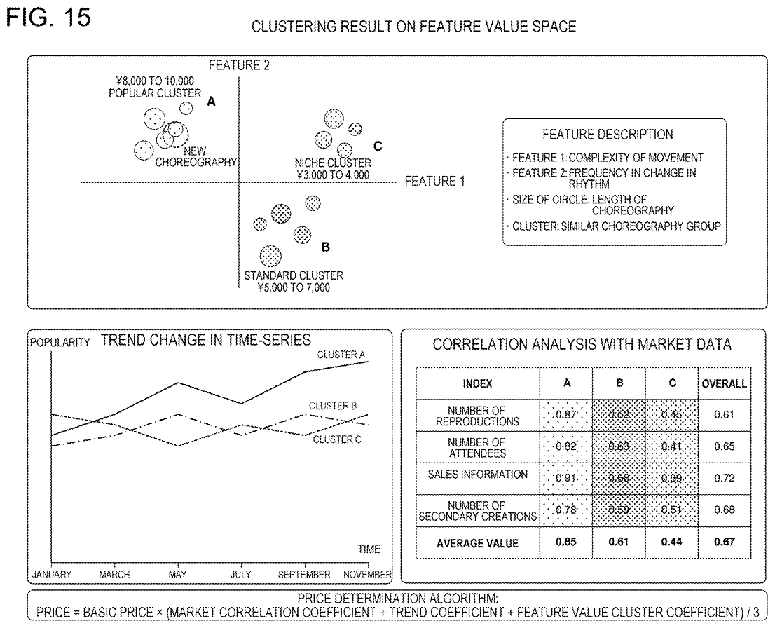

Next, the analysis function will be described. FIG. 15 is a conceptual diagram of a choreography value measurement and automatic pricing system, and visually represents a series of processes from feature value analysis of choreography data to measurement of market value and automatic price setting. This diagram is composed of three main sections, each showing a different aspect in the value measurement of the choreography.

As illustrated in the “clustering result on feature value space” section at the upper part, the analysis function can arrange the feature value of the choreography on the two-dimensional space and collectively form a cluster of choreographies having similar characteristics. The horizontal axis represents the complexity of movement as “feature 1”, the vertical axis represents the frequency in change in rhythm as “feature 2”, and the size of the circle represents the length of the choreography. Three main clusters are formed in this space. A “popular cluster A” is positioned in a high price range (\8,000 to 10,000), “standard cluster B” is positioned in a medium price range (\5,000 to 7,000), and “niche cluster C” is positioned in a relatively low price range (\3,000 to 4,000). The point surrounded by the dotted line represents the newly analyzed choreography, and it is predicted from the position to belong to the popular cluster A. This visualization shows that the relevance between the characteristics of the choreography and the market value can be intuitively understood. The analysis function can generate the clustering described above, a characteristic indicating to which cluster the choreography to be analyzed belongs, and the illustrated information, and output the generated information to the user.

In the “trend change in time-series” section at the bottom left, the transition of popularity of each cluster in the period from January to November is graphed. The analysis function can generate and output such information toward the user. Cluster A indicates a tendency of increasing in popularity with the elapse of time, and in particular, increases rapidly toward the second half. Cluster B fluctuates gradually while maintaining moderate popularity, and cluster C tends to rise at a specific timing while having relatively low popularity. This graph provides information that can be used for future value prediction by tracking changes in acceptability of each cluster in the market in time-series and grasping the tendency of the trend. The popularity can be calculated using various techniques. For example, the analysis function may calculate popularity based on material values such as the number of reproductions, the number of attendees, sales information, and the number of secondary creations. The analysis function can calculate higher popularity the higher the material value. The calculation can be achieved using, for example, a calculation model in which a material value is the input and a popularity is the output. The calculation model may be an arithmetic expression, may be a model that outputs a value related to an input by referring to a table indicating a correspondence relationship between material value and popularity, or may be other models.

In the “correlation analysis with market data” section at the bottom right, the relevance between the characteristics of each cluster and the actual market index is shown in tabular form in detail. The analysis function can perform such analysis, generation of information, output for a user, and the like. The market index to be analyzed includes the number of reproductions on a moving image site, the number of attendees of a concert or the like, sales information of a video medium or the like, and the number of secondary creations. The analysis function can perform correlation analysis between the feature value of the choreography and at least one of the market data of the number of reproductions on a moving image site, the number of attendees of a concert, and sales information of a video medium. Cluster A shows a very high correlation coefficient (0.78 to 0.91) with all the indexes, and in particular, the correlation with the sales information is 0.91, that is the highest, and a strong connection with the market value can be confirmed. Cluster B shows a moderate correlation (0.52 to 0.68), and cluster C has a relatively low correlation (0.39 to 0.51). These correlation analyses convert, into numerical values, how the characteristics of the choreography are related to the actual market performance, and provide an objective basis for value measurement.

A schematic formula of the price determination algorithm is described at the lowermost part of the figure. The analysis function can automatically set the price by, for example, a calculation method of “price=basic price×(market correlation coefficient+trend coefficient+feature value cluster coefficient)/3”. This algorithm is a mechanism for calculating a price by comprehensively considering three main factors of a correlation of market data, a temporal trend, and a cluster position in a feature value space.

With this system, it is possible to measure the value of the choreography objectively and in accordance with the actual situation of the market, and to automate appropriate price setting. This serves as a basis for a choreographer to obtain an appropriate consideration for a work, and also has an effect of making it easier for a content producer such as VTuber to make a budget plan in using choreography. In addition, this data-driven value evaluation system enhances the transparency and efficiency of the entire choreography market and contributes to the formation of a more sound creation ecosystem.

### Details of Search Function

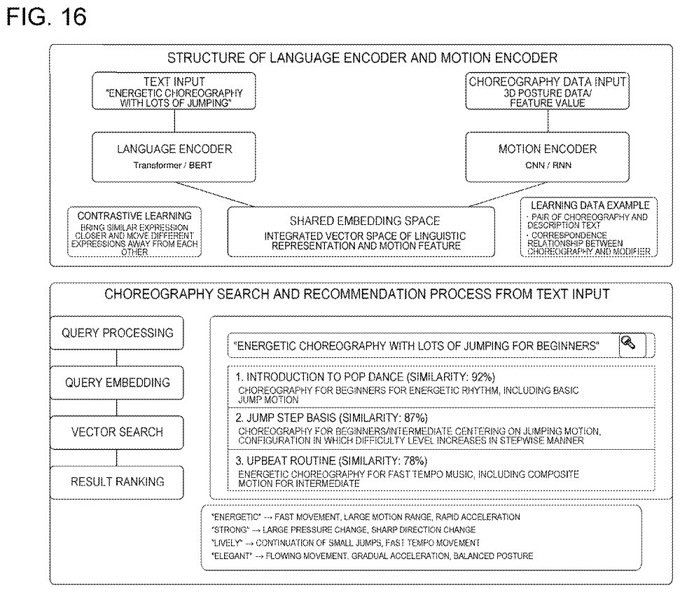

Next, the choreography search function in natural language will be described. FIG. 16 is a configuration diagram of a choreography search system using a natural language, and illustrates a technical mechanism for achieving search and recommendation of intuitive choreography using words. This figure is divided into upper and lower two main sections, where an integrated model structure of language processing and motion processing is represented at the upper part, and an actual search process and a user interface are represented at the lower part.

In the “structure of language encoder and motion encoder” section at the upper part, the search function converts different types of data, language and motion, into a common representation space. On the left side, text inputs such as “energetic choreography with lots of jumping” are processed by the language encoder. This language encoder utilizes a natural language processing model such as Transformer or Bidirectional Encoder Representations from Transformers (BERT), and converts semantic content of a sentence into a high-dimensional vector space. On the other hand, on the right side, the motion information of the choreography such as the 3D posture data and the feature value is processed by the motion encoder. This motion encoder extracts and vectorizes features of time-series motion data using a deep learning model such as a Convolutional Neural Network (CNN) or a Recurrent Neural Network (RNN). The outputs of these two encoders are projected into a “shared embedding space” shown at the center lower part, and the linguistic representation and the motion features are represented in the same multidimensional space. A method of “contrastive learning” is used for the learning of the shared space, and the vectors of semantically similar linguistic representation and motion features are trained to be arranged close to each other and different ones are trained to be away from each other. In this learning process, learning data such as “a pair of choreography and description text” or “a correspondence relationship between choreography and modifier” is used.

In the “choreography search/recommendation process from text input” section at the lower part, the actual search flow using the learned model is shown. On the left side, stages of the search processing (“query processing”, “query embedding”, “vector search”, and “result ranking”) are arranged from top to bottom. The search function first preprocesses the text input from the user by language processing, and converts the text into a vector in the shared embedding space by the language encoder. The search function calculates the similarity with all the choreography vectors in the database based on the query vector, and outputs a result ranked in descending order of the similarity. An example of an actual search interface is shown on the right side. Specifically, three search results of “introduction to pop dance” (similarity 92%), “jump step basis” (similarity 87%), and “upbeat routine” (similarity 78%) are displayed for the search query of “energetic choreography with lots of jumping for beginners”. A simple explanation is attached to each result, and it is easy for the user to select the choreography most suitable for his/her needs.

At the lowermost part of the drawing, an example of which physical motion characteristic the linguistic representation relates to is illustrated as an “example of correspondence between abstract expression and motion feature”. For example, the abstract expression “energetic” is associated with a specific motion characteristic of “fast movement, large motion range, rapid acceleration”, and “elegance” relates to “flowing movement, gradual acceleration, balanced posture”. Similarly, expressions such as “strong” and “lively” are each converted into specific motion parameters.

With such a choreography search system using natural language, the user can search for the desired choreography using daily words and sensuous expressions without knowing specialized motion terms and technical parameters. For example, it is possible to find an appropriate choreography from various expressions such as “energetic choreography for beginners”, “Japanese calm movement”, and “mechanical choreography like a robot”. In addition, the accuracy of this system is improved as learning is repeated, and the correspondence relationship between more various linguistic representations and motion characteristics can be understood. As a result, it becomes easier to search and select choreography in the VTuber market, and the matching between the content producer and the choreographer is made efficient, so that the technique also contributes to the activation of the entire market.

### Third Example Embodiment

### Background and Outline

This example embodiment further develops the basis of the copyright management system established in the first example embodiment and the user-oriented function achieved in the second example embodiment, and proposes a system in which an automatic generation technique of choreography and a verification function of generated content are integrated. With the rapid expansion of the digital content market, demand for high-quality choreography content is continuously increasing, but creation by skilled choreographers has temporal/human constraints. This example embodiment addresses this problem, and aims to improve the efficiency of the creation process and expand new expressive possibility by achieving an automatic generation function of choreography utilizing a generative Artificial Intelligence (AI) technique.

Specifically, it is possible to automatically generate various and creative choreographies based on input conditions by a choreography generation function based on a deep learning model. The user only needs to specify conditions such as music data, a desired dance style, and a difficulty level to generate the choreography data adapted thereto. As a result, efficiency improvement of prototyping and creation support of choreography, variation development, and the like is achieved.

As a further important function, there is a “pruning function” for automatically verifying the copyright infringement risk of the generated choreography. This function applies the similarity determination technique described in the first example embodiment, and detects/modifies a portion having a high similarity with the existing choreography in the generation process, thereby preventing copyright infringement in advance. In addition, a function of creatively deforming the detected high similarity portion is also implemented to achieve a choreography generation that maintains an artistic value while reducing a legal risk.

The generative AI is a concept including a Large Language Model (LLM). The generative AI can include an image analysis model. The generative AI interprets the content of a prompt input in a natural language, generates an answer to the input prompt based on data learned in advance, and outputs the answer expressed in the natural language. The generative AI can, for example, learn a huge amount of various data disclosed on the Internet. The generative AI can receive an input of an image or the like together with the prompt, interpret the content of the input image or the like, and generate an answer reflecting a result of the interpretation. The generative AI can also generate and output an image. The device in this example embodiment may input a prompt input by the operator to the generative AI. In addition, the device in this example embodiment may read out a prompt registered in advance by the operator and input the prompt to the generative AI. In addition, the device in this example embodiment may read out a prompt according to a predetermined rule from a plurality of prompts registered in advance by the operator, and input the prompt to the generative AI. In addition, the device in this example embodiment may generate a prompt by embedding predetermined information in a blank portion of the prompt registered in advance by the operator, and input the prompt to the generative AI. The device in this example embodiment may acquire information to be embedded in the blank portion from another device (a server or the like), may generate the information by the own device, or may accept an input from a user. In addition, the device in this example embodiment may generate a prompt according to a predetermined rule, and input the generated prompt to the generative AI. The device in this example embodiment may input reference information to be referenced to the generative AI together with a prompt. The device in this example embodiment may input the reference information input by the operator to the generative AI. Furthermore, the device in this example embodiment can acquire reference information from another device (server etc.) and input the reference information to the generative AI. In addition, the device in this example embodiment can generate the reference information according to a predetermined rule and input the generated reference information to the generative AI. The generative AI is, for example, ChatGPT, Gemini, Firefly, Claude, or the like, but is not limited thereto. The device in this example embodiment may include the generative AI. In addition, an external device configured to be able to communicate with the device in this example embodiment may include the generative AI.

Such generative AI is implemented by, for example, a neural network. The neural network includes a plurality of artificial neurons and has synapses connecting the neurons. Each synapse has a weight. In a case where an input is accepted, such a neural network performs calculation using a weight associated with each synapse, and performs output according to the input. The model representing the connection relationship between the neuron and the synapse is saved, for example, in the memory in the form of software. Alternatively, the model may be implemented as a dedicated circuit. Similarly, the weight of each synapse is also stored in the memory in the form of software. A circuit representing a weight may be mounted in a dedicated circuit. In a case where the generative AI is configured using a plurality of models, not all the models are necessarily saved in the same memory. There are various models using such a neural network. The generative AI may be implemented by adopting/replacing various models such as a Transformer, a Convolutional Neural Network (CNN), and a Recurrent Neural Network (RNN).

### Flow of Processing

The flow of processing in this example embodiment will be described. While the first and second example embodiments mainly focus on management and utilization of existing choreography data, this example embodiment achieves a processing flow focusing on creation of new choreography and legal risk management thereof.

First, the processing starts with “setting of input conditions”. Here, the computer accepts designation of various parameters necessary for generating the choreography from the user. Specifically, conditions such as music data (tempo, rhythm, melody, etc.), a dance style (pop, hip-hop, contemporary, etc.), a difficulty level (beginner, intermediate, advanced), a length of choreography, presence or absence of a specific motion element (jump, rotate, etc.), and an emotion or atmosphere desired to be expressed (energetic, elegant, etc.) are input. These conditions function as control parameters of the generation model in the next step.

Next, the process proceeds to the step of “execution of choreography generation model”. Here, the generation model (Utilizing architectures such as Transformer, GAN, VAE) based on deep learning generates the choreography data based on the condition input in the previous stage. The generation model is pre-learned with a large amount of a choreography data set, and outputs the choreography as a time-series of 3D posture data from the expression in the latent space related to the input condition. In this process, a probabilistic generation process is adopted, and a mechanism is employed in which a different variation of the choreography is generated every time even under the same input condition.

The generated choreography data is sent to a step of “physical constraint check”. Here, the computer verifies the feasibility of the choreography in light of the movable range of the joint of the human body and the constraint conditions based on the laws of physics (gravity, inertia, etc.). In a case where an unnatural posture or a physically unfeasible movement is detected, adjustment is performed by an automatic correction algorithm. This process guarantees that the generated choreography is indeed naturally feasible by humans or VTuber models.

The choreography data for which the physical constraint has been cleared is then sent to the “similarity determination function”. Here, the similarity determination technique developed in the first example embodiment is applied, and the computer calculates the similarity between the generated choreography and the choreography registered in the existing choreography database. In particular, emphasis is placed on the detection of a partial match, and a portion having high similarity with the existing characteristic choreography is specified even in a short sequence. The similarity is scored for each segment and visualized in a heat map format.

Subsequently, in a step of “similarity threshold value determination”, the computer compares the calculated similarity with a threshold value set in advance. A portion having similarity equal to or less than the threshold value is kept as it is, while a portion having high similarity exceeding the threshold value is sent to a step of “copyright infringement avoidance processing”. Here, a special algorithm called “pruning function” is applied, and a creative deformation of the high similarity portion is performed.

In the “pruning function”, two main processes are executed. The first is “feature value space conversion”, and the computer performs processing of searching a region having a low density of the existing choreography in the feature value space of the choreography, and displacing a high similarity portion to a low density region. The second is “alternative pattern generation”, and the computer generates and replaces different movement variations while maintaining the intent and expression of the original choreography. In these processes, not only a simple movement change but also a creative deformation for avoiding copyright infringement while retaining an artistic value and an expression intention of the choreography is performed.

The deformed choreography portion is integrated with the original choreography data, and is fed back to the “similarity determination function” again. This is to evaluate the similarity again for the entire choreography after the deformation, and this feedback loop is repeated until all the segments have the similarity equal to or less than the threshold value.

The choreography data in which all the copyright infringement risks are eliminated is finally sent to a step of “final output processing”. Here, the computer performs format conversion, optimization, metadata assignment, and the like of the choreography data, and prepares transfer to the downstream processing described in the second example embodiment, such as application to the VTuber model and generation of learning support material. In addition, the computer records provenance information such as a creation process and a deformation history of the generated choreography, and saves it as important data from the viewpoint of later rights management and explanation responsibility.

As described above, in the processing flow of this example embodiment, a system in which automatic generation of creative choreography and automatic detection/avoidance of copyright infringement are integrated is achieved. A technical base related to the modern problem of achieving both the generated content by the generative AI and the protection of the intellectual property rights is provided, and an efficient workflow for simultaneously achieving the idea support of the creator and the reduction of the legal risk is constructed.

### Choreography Generation Function

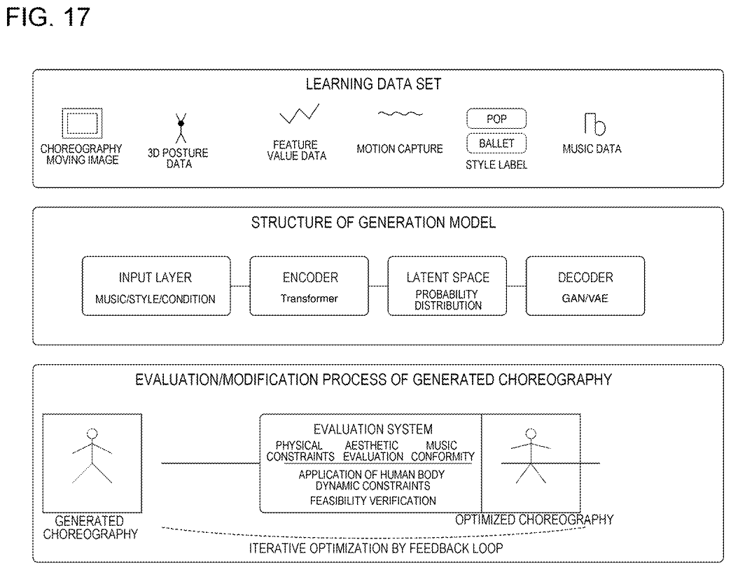

Next, the choreography generation function will be described. FIG. 17 is a configuration diagram of the AI choreography generation system, and illustrates a technical mechanism and a processing process for automatically generating new choreography using a machine learning model. This diagram is composed of three main sections from top to bottom, and systematically expresses a series of flows from collection of data to optimization of final choreography.

In the “learning data set” section at the uppermost part, a wide variety of data sources used for learning by the AI choreography generation model are shown. A choreography moving image by an actual dancer, skeleton data extracted by a 3D posture detection technique, feature value data obtained by converting features of choreography into numerical values, motion capture data by a dedicated device, a dance-style label such as pop or ballet, and music data are arranged in order from the left. By combining these various types of data, the AI model learns the pattern of the movement of the choreography, the rhythmic sense, the features of the dance style, and the like, and builds the basis for generating creative and feasible choreography.

In the “structure of generation model” section at the center, the architecture of the machine learning model for generating the choreography data is illustrated. This model is composed of four main components in which the processing proceeds from left to right. In the first “input layer”, the choreography generation function accepts inputs of conditions such as music data, a desired dance style, a length and a difficulty level of choreography, and the like. In the next “encoder”, the choreography generation function transforms the input data into a high-dimensional feature representation using a deep learning architecture such as a Transformer. In the following “latent space”, the choreography generation function expresses the encoded data as a probability distribution, and samples the encoded data from the probability distribution to generate diverse choreographies. In the last “decoder”, the choreography generation function restores specific choreography data from the latent expression using a generation model such as Generative Adversarial Networks (GAN) or VAE. Such a combination of advanced machine learning techniques achieves automatic generation of creative and various choreographies.

In the “evaluation/modification process of generated choreography” section at the lower part, the choreography generation function evaluates the choreography data generated by the generative AI and optimizes it to one that can be actually danced. The “generated choreography” on the left side represents unmodified choreography data initially output by the generative AI, and is visualized by an illustration of a stick figure. In the “evaluation system” at the center, the choreography generation function evaluates the generated choreography from a plurality of viewpoints such as physical constraints (movable range of joints, etc.), aesthetic evaluation (gracefulness of movement and power of expression), and music conformity (consistency with rhythm). There are various evaluation methods. Here, the choreography generation function also verifies application of human body dynamic constraints and feasibility by an actual human. The “optimized choreography” on the right side represents choreography refined in a form that can be achieved through evaluation and modification. The dotted line at the lowermost part indicates “iterative optimization by feedback loop”. The choreography generation function can gradually evolve the choreography into high-quality choreography by repeatedly modifying the choreography based on the evaluation result.

In one example, physical constraints, aesthetic evaluation, and music conformity are evaluated as follows.

### Specific Example of Evaluation Method of Physical Constraint

(1) Check movable range of joint:

The choreography generation function verifies, in each frame of the generated 3D choreography data, whether the joint angle is not deviated from a medically/anatomically defined movable range (e.g., elbow 0 to 145 degrees, etc.). In a case where deviation is observed, the choreography generation function applies an algorithm for forcibly clipping the angle (rounding the upper limit/lower limit) or correcting the movement to a more natural movement.

(2) Verification of balance and center of gravity

The choreography generation function determines whether the center of gravity of the skeleton model is greatly deviated from the foot sole surface (a range supported by both feet), and prevents an impossible motion in which the balance is lost. In a case where the center of gravity is deviated, the choreography generation function finely adjusts the joint position and corrects the position of the center of gravity in such a way as to remain on the foot sole surface.

(3) Evaluation of motion dynamics parameters

The choreography generation function calculates the momentum, acceleration, estimated load, and the like of each joint or the whole body, and determines that the motion as a motion that exceeds the feasibility of the body in a case where excessive speed change/acceleration occurs. The choreography generation function regenerates a choreography pattern that reduces the motion speed and disperses the impulse as necessary.

(4) Collision determination and detection of posture interference

The choreography generation function detects a motion in which terminal parts such as an arm/leg in the skeleton model collide with each other (intersection or penetration occurs), and modifies the motion such that interference is minimized, for example, recalculation of a joint trajectory is performed in a frame in which the intersection amount is large.

### Specific Example of Method of Aesthetic Evaluation

(1) Model-based aesthetic Index

The choreography generation function refers to a typical “beautiful posture” or “reference value of line (elongation of limbs and spine, angle of elbow, etc.)” bibliographically known for each dance style such as ballet or contemporary, and compares the posture with the generated choreography. Then, the choreography generation function increases the score for a portion having a high degree of coincidence and decreases the score for an unnatural posture or motion.

(2) Evaluation of gracefulness/continuity

The choreography generation function performs autocorrelation and spectral analysis on the time-series skeleton data to quantify whether the motion is smoothly connected without interruption. The choreography generation function lowers the aesthetic evaluation in a case where a sudden stop or an excessive speed change continues.

(3) Silhouette extraction algorithm

The choreography generation function analyzes a change in an outline (silhouette) in time-series at the time a 3D skeleton is two-dimensionally projected, and increases the aesthetic evaluation as the frames having a symmetrical and beautiful silhouette change increase. For example, in a case where left-right asymmetry is too strong or there are too many repetitive movements, the choreography generation function determines that the artistic value is low and adjusts the score.

(4) Aesthetic determination by machine learning

The choreography generation function inputs motion videos and feature value vectors and estimates an aesthetic score by using a model (e.g., a “likability” estimation model using CNN or Transformer) that has learned evaluation data from actual dancers and spectators. The choreography generation function automatically learns the evaluation close to the aesthetic sense of the human and reflects it in the final evaluation.

### Specific Example of Evaluation Method of Music Conformity

(1) Beats Per Minute (BPM) conformity degree

The choreography generation function compares the BPM of the music with the main motion timing of the choreography (the frame in which the joint speed/acceleration becomes maximum), and converts the concordance rate to a numerical value. The choreography generation function determines that the higher the concordance rate is, the more the movement is in rhythm.

(2) Evaluation of synchronization with time/bar structure

In a case where the music is in quadruple time or the like, the choreography generation function determines how much a predetermined bar boundary and a motion break (large posture switching or accent frame) conform. The choreography generation function aggregates changes in the angles and positions of the main joints for each bar break and scores the conformity degree.

(3) Dynamics evaluation

The choreography generation function determines that the adaptability to music is higher as the volume change or excitement (crescendo, decrescendo) of the music and the change in the motion intensity (speed/acceleration/number of frames with large movement) during the choreography overlap.

(4) Genre matching

In a case where there is a characteristic rhythm pattern or step according to a music genre (e.g., Jazz/hip-hop), the choreography generation function compares the elements with a predetermined weight, and evaluates to what extent the movement capturing the genre property of the music is incorporated.

The choreography generation function may perform arithmetic processing on these three viewpoints (physical constraints, aesthetic evaluation, music conformity) and calculate a total score obtained by integrating each of the results. It may be designed such that in a case where the total score falls below the reference value, automatic modification or regeneration is performed, and finally, choreography that is feasible and excellent in art/expressive power is obtained.

With such an AI choreography generation system, it is expected to support the creativity of the choreographer and expand the possibility of new dance expression. For example, it is possible to automatically generate a plurality of candidates at the stage of brainstorming of the choreography, search for a new expression combining existing choreography styles, and automatically complement the movement intended by the choreographer. In addition, in the VTuber market, it can be utilized as a basic technique that meets various needs, such as efficient generation of choreography in accordance with characteristics of characters and provision of customized choreography according to user's request. Furthermore, this technique cooperates with a copyright management system, so that it is possible to generate a new choreography while evaluating similarity with an existing choreography, and minimize a copyright infringement risk.

### Pruning Function

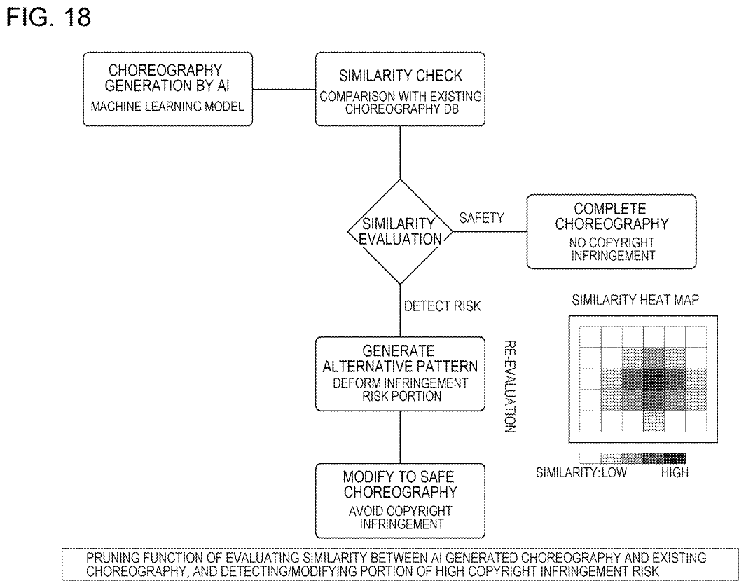

Next, the pruning function of choreography generation will be described. FIG. 18 is a diagram for describing an infringement avoidance function in the choreography generation. This diagram shows an overview image of the “pruning function” for avoiding copyright infringement in the choreography generation process by the generative AI.

First, starting from the generation of the choreography by the generative AI located at the upper left in the drawing, the choreography is automatically created using the machine learning model. Next, the pruning function proceeds to a process of similarity check on the created choreography data, and performs comparison with an existing choreography database. Thereafter, the pruning function determines, in a similarity evaluation step, whether the generated choreography is similar to an existing work. For example, the pruning function determines as “safe” in a case where the similarity is equal to or less than a threshold value, and detects “risk” in a case where the similarity is greater than the threshold value. If determined as safe in the evaluation process, the pruning function proceeds to the “complete choreography” box on the right side to complete the choreography as a choreography without copyright infringement. On the other hand, if a risk is detected, the processing proceeds in a downward direction, and the pruning function enters a process of “generate alternative pattern”. Here, the pruning function deforms the choreography for a portion having infringement risk (e.g., a portion whose similarity to the existing choreography is equal to or greater than a threshold value), and makes a modification to avoid copyright infringement. The pruning function then adjusts the choreography to avoid copyright infringement in the step of “modify to safe choreography”. In the pruning function, the similarity evaluation is performed again with respect to the modified choreography, and the re-modification is repeated as necessary until the safety is confirmed. A similarity heat map is shown on the right side of the drawing, which visually shows which part of the choreography is similar to the existing work. It is expressed by a gradation from white to black, and a darker color means a higher similarity and a higher risk of copyright infringement. Each cell of the heat map relates to a partial region (one pixel or a set of a plurality of pixels) in the video in which the choreography is recorded (the video in which the person dancing is recorded). For example, in the pruning function, the translucent heat map may be superimposed and displayed on the video in which the choreography is recorded. By referring to this heat map, it is easy to specify a portion that requires modification. With this system, a creation activity respecting the existing choreography copyright becomes possible while securing the uniqueness of the choreography created by the generative AI.

### Modified Example of Choreography

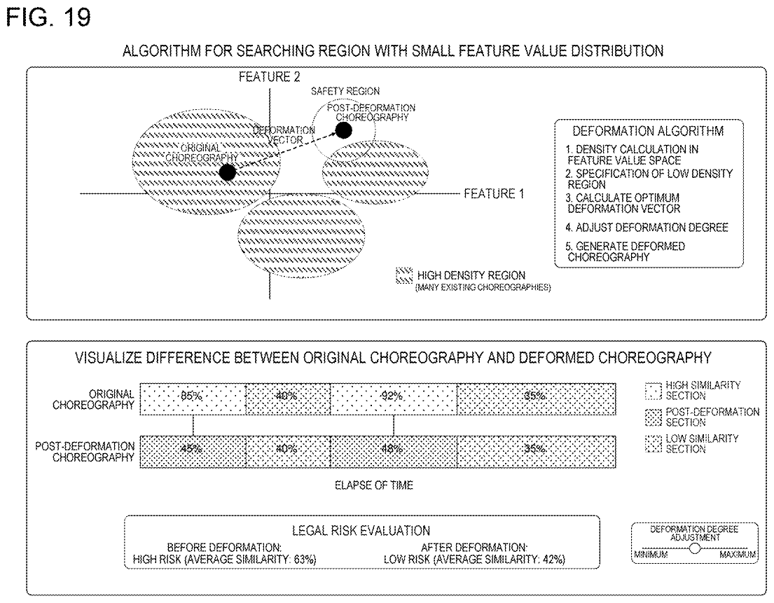

A choreography deformation function for avoiding copyright infringement will be described. FIG. 19 is a diagram of a choreography deformation function for avoiding copyright infringement, and visually represents a technical mechanism for reducing a risk that a creation similar to an existing choreography is determined as copyright infringement. This diagram is composed of two upper and lower main sections, where an algorithm of deformation and a conceptual feature value space are shown at the upper part, and effects and evaluations of specific deformation are shown at the lower part.

In the “algorithm for searching region with small feature value distribution” section at the upper part, a state in which the feature of the choreography is mapped on a two-dimensional feature value space is illustrated. The horizontal axis and the vertical axis each represents different characteristics of the choreography as “feature 1” and “feature 2”, and a region indicated by an ellipse represents a “high density region” where many existing choreographies are concentrated. The “original choreography” indicated by a black dot in this space is located in the high density region, which means that the similarity with the existing choreography is high. The choreography deformation function searches a “low density region” having few existing choreographies in the feature value space, and moves the original choreography along a “deformation vector” indicated by a dotted arrow. As a result, the “post-deformation choreography” indicated by the black dot moves to a position away from the high density region and is arranged in the “safety region” surrounded by the dotted circle. In the box on the right side, five steps of the deformation algorithm are described, and a processing flow from the density calculation in the feature value space to the generation of the final deformed choreography is described. The choreography deformation function can generate information as illustrated and output the information toward the user.

In the “visualization of difference between original choreography and deformed choreography” section at the lower part, a specific state of deformation along a time axis is illustrated. The “original choreography” in the upper stage is divided into four sections according to the elapse of time, and two high similarity sections have high similarity (85% and 92%) to the existing choreography, and the other two low similarity sections have low similarity (40% and 35%) to the existing choreography. In the “post-deformation choreography” in the lower stage, it is illustrated that the similarity between the two high similarity sections is significantly decreased (45% and 48%). On the other hand, the low similarity section originally having low similarity is kept unchanged. As described above, the deformation processing executed by the choreography deformation function indicates an efficient approach of selectively changing only a portion having a high copyright infringement risk and saving a unique portion having high creativity. The choreography deformation function can generate information as illustrated and output the information toward the user.

At the lowermost part, as “legal risk evaluation”, a numerical value indicating that the average similarity of the entire choreography has been reduced from 63% (high risk) before the deformation to 42% (low risk) after the deformation is illustrated. On the right side, a slider of “deformation degree adjustment” is drawn, indicating that the user can adjust the strength of deformation from the minimum to the maximum. The choreography deformation function can generate information as illustrated and output the information toward the user.

As a result, a function is provided in which a user himself/herself can flexibly select to what extent the essential expression or intention of the original choreography is to be retained while avoiding copyright infringement.

With this choreography deformation function, a creator of choreography or a user such as VTuber can generate a new expression with a minimized risk of copyright infringement while being affected by existing choreography. The system supports both legal safety and creativity in creative activities by performing objective deformation based on analysis of a feature value space and quantitatively evaluating a legal risk. In the era of AI-generated content, this technique has become an important tool for achieving an appropriate balance between copyright protection and freedom of creation.

### Screen Example of User Interface

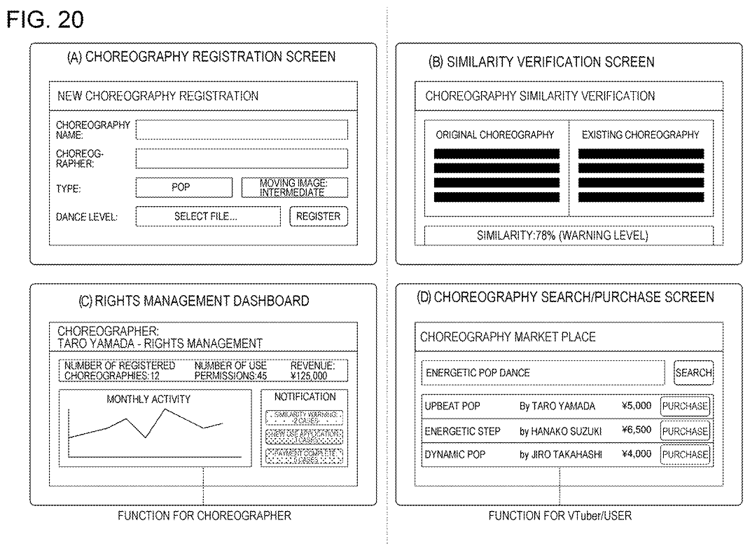

A user interface of this example embodiment will be described. FIGS. 20A to 20D are diagrams of a user interface of a system and a use case example, and an actual operation screen of the choreography copyright management system and a usage scenario thereof are visually represented with four panels. These panels illustrate the function related to two main user sections, choreographer and user, and specifically illustrate the overall operability and practicability of the system.

The panel (a) illustrates a choreography registration screen, and is an interface for the choreographer to register the choreography he/she created in the copyright management system. At the upper part of the screen, a header “new choreography registration” is emphasized by a blue bar, and basic information input fields such as a choreography name, a choreographer name, a type (pop), and a dance level (intermediate) are arranged below the header. In addition, an input field for selecting a moving image file of the choreography and a blue “registration” button for executing the registration processing are also provided. With this interface, the choreographer can easily and conveniently register his/her own creation and take the first step in protecting rights.

The panel (b) represents a similarity verification screen, and a function of visually and quantitatively evaluating the similarity between the choreography to be newly registered and the existing choreography is provided. There is a section of “original choreography” on the left side of the screen and a section of “existing choreography” on the right side, and for example, a time-series choreography structure is expressed in different color tones. In one example, the left side is indicated by a red color and the right side is indicated by a blue color, and the degree of similarity is visualized by gradation. A comprehensive evaluation of “similarity: 78% (warning level)” is displayed at a lower part of the screen, and this numerical value is an important index indicating the possibility of copyright infringement. With this verification function, an unintended copyright infringement risk can be detected in advance, and modification of the choreography and a use permission application can be urged as necessary.

The panel (c) is a rights management dashboard, and is an interface for the choreographer to centrally manage the usage status and revenue of the choreography he/she registered. “Choreographer: Taro Yamada-Rights Management” is displayed at the upper part of the screen, and below it, outline information such as the number of registered choreographies (12), the number of use permissions (45), and revenue (\125,000) can be seen at a glance. A graph of the monthly activity is displayed on the left side, and the use tendency of the choreography and the change in popularity can be grasped in time-series. In the notification area on the right side, important notifications such as “similarity warning: 2 cases”, “new use application: 3 cases”, and “payment complete: 5 cases” are displayed, for example, in a color-coded manner, and it is designed to be able to clearly recognize matters that require quick response.

The panel (d) is a choreography search/purchase screen, and shows a marketplace function for searching for choreography required by a user such as a VTuber and purchasing it legally. In the search bar at the upper part of the screen, the keyword “energetic pop dance” is input, indicating that search in natural language is possible. Three choreographies of “upbeat pop” (\5,000), “energetic step” (\6,500), and “dynamic pop” (\4,000) are displayed as the search results, and a choreographer name, a price, and a “purchase” button are given to each choreography. With this interface, the user can easily find the choreography of the desired characteristic, and can legally use the choreography by paying an appropriate price.

At the lowermost part of the drawing, sections of “function for a choreographer” and “function for a VTuber/user” are indicated by dotted lines, and it is clearly indicated that (a) and (c) are functions for a choreographer and (b) and (d) are functions for a user. As described above, this system provides a user interface from both viewpoints, and achieves an environment in which a series of processes of creation, registration, verification, management, search, and purchase of a choreography can be smoothly executed. An important feature of this example embodiment is that a benefit of a copyright management system can be received without technical expertise by an intuitive and easy to use interface design.

### Fourth Example Embodiment

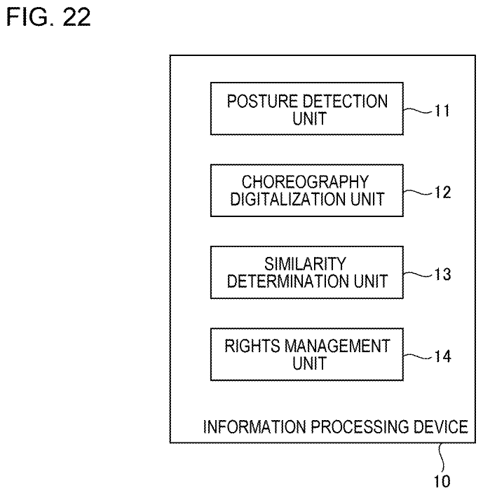

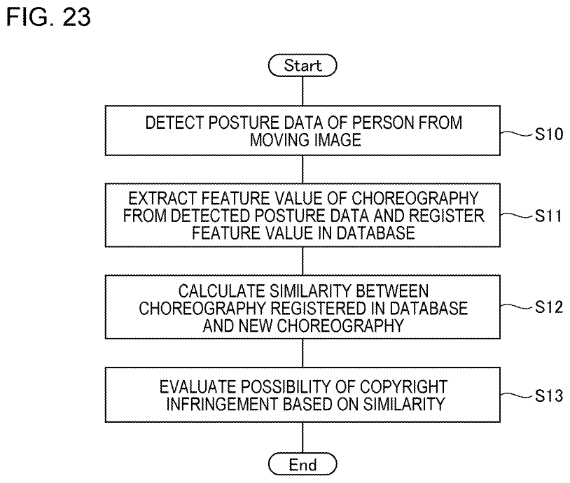

FIG. 22 is a functional block diagram illustrating an outline of an information processing device 10. FIG. 23 is a flowchart illustrating an example of a flow of processing executed by the information processing device 10.

As illustrated in FIG. 22, the information processing device 10 includes a posture detection unit 11, a choreography digitalization unit 12, a similarity determination unit 13, and a rights management unit 14. The processing illustrated in the flowchart of FIG. 23 is executed by these functional units.

In S10, the posture detection unit 11 detects posture data of a person from the moving image.

In S11, the choreography digitalization unit 12 extracts the feature value of the choreography from the detected posture data and registers the feature value in the database.

In S12, the similarity determination unit 13 calculates the similarity between the choreography registered in the database and the new choreography.

In S13, the rights management unit 14 evaluates the possibility of copyright infringement based on the similarity.

According to such an information processing device 10, it is possible to utilize a quantitative evaluation result of human motion for evaluation of the possibility of copyright infringement. As a result, it is possible to develop a technique that utilizes a quantitative evaluation result of human motion.

### Hardware Configuration

Next, an example of a hardware configuration of the devices of the first to fourth example embodiments and at least one device constituting the system in these example embodiments will be described. Each functional unit of each device is achieved by an arbitrary combination of hardware and software. It is to be understood by those skilled in the art that there are various modified examples of a method and device for implementing the functional units. The software includes a program stored in advance from a stage of shipping the device, a program downloaded from a recording medium such as a Compact Disc (CD), a server on the Internet, or the like.

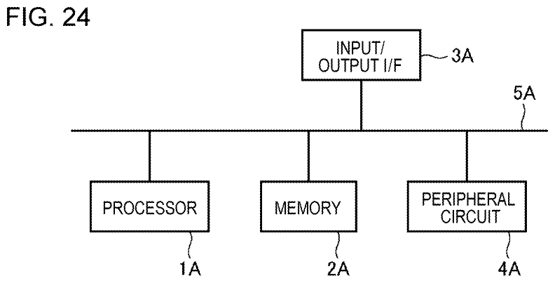

FIG. 24 is a block diagram illustrating a hardware configuration of each device. As illustrated in FIG. 24, each device includes a processor 1A, a memory 2A, an input/output interface 3A, a peripheral circuit 4A, and a bus 5A. The peripheral circuit 4A includes various modules. Each device may not include the peripheral circuit 4A. Each device may include a plurality of physically and/or logically separated devices. In that case, each of the plurality of devices may have the hardware configuration described above.

The bus 5A is a data transmission path through which the processor 1A, the memory 2A, the peripheral circuit 4A, and the input/output interface 3A mutually transmit and receive data. The processor 1A is, for example, an arithmetic processing device such as a Central Processing Unit (CPU) or a Graphics Processing Unit (GPU). The memory 2A is, for example, a memory such as a Random Access Memory (RAM) or a Read Only Memory (ROM). The input/output interface 3A includes an interface for acquiring information from an input device, an external device, an external server, an external sensor, a camera, and the like, and an interface for outputting information to an output device, an external device, an external server, and the like. The input/output interface 3A includes an interface for connecting to a communication network such as the Internet. The input device is, for example, a keyboard, a mouse, a microphone, a physical button, a touch panel, or the like. The output device is, for example, a display, a projection device, a speaker, a printer, a mailer, or the like. The processor 1A may issue a command to each of the modules and perform calculation based on calculation results of the modules.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. Each example embodiment can be combined with other example embodiments as appropriate.

In the flowcharts used in the descriptions above, a plurality of steps (processing) are described in order. However, execution orders of the steps executed in each example embodiment are not limited to the described orders. In each example embodiment, the order of the illustrated steps may be changed as long as no problem is raised in content.

Some or all of the example embodiments described above may be described as, but are not limited to, the following Supplementary Notes.

1. An information processing device including
a posture detection means for detecting posture data of a person from a moving image,
a choreography digitalization means for extracting a feature value of a choreography from the detected posture data and registering the feature value in a database,
a similarity determination means for calculating a similarity between the choreography registered in the database and a new choreography, and
a rights management means for evaluating a possibility of copyright infringement based on the similarity.

2. The information processing device according to 1, in which
the choreography digitalization means extracts, as a feature value, time-series data including at least one of a relative positional relationship of body parts, a velocity vector, an acceleration vector, and an angular change of a movement.

3. The information processing device according to 1 or 2, in which
the similarity determination means has a function of providing a threshold value of the similarity and notifying that there is a possibility of copyright infringement in a case where the similarity exceeds the threshold value.

4. The information processing device according to any one of 1 to 3, in which
the rights management means has a function of distributing a reward related to use of the choreography to the choreographer.

5. The information processing device according to any one of 1 to 4, in which
the rights management means has a function of managing partial joint copyright of a choreography by a plurality of choreographers.

6. The information processing device according to any one of 1 to 5, further including
a function of applying the detected posture data to an avatar and reproducing it with a 3D model.

7. The information processing device according to any one of 1 to 6, further including
a function of analyzing a difficulty level and a feature of a choreography and providing learning support information.

8. The information processing device according to any one of 1 to 7, further including
a function of generating a new choreography using a machine learning model, and evaluating/modifying a feasibility and a human body dynamic conformity in a 3D posture estimation system.

9. The information processing device according to 8, further including
a pruning function of evaluating similarity between the choreography generated by the machine learning model and an existing choreography, and detecting/modifying a portion having a high risk of copyright infringement.

10. The information processing device according to any one of 1 to 9, further including
a function of performing a correlation analysis between the feature value of the choreography and at least one of the number of reproductions of a moving image site, the number of attendees of a concert, and market data of sales information of a video medium in the database, measuring a value of the choreography based on a result of the correlation analysis, and performing pricing at the time of selling the choreography based on the value.

11. The information processing device according to any one of 1 to 10, further including
a function of performing learning to embed a feature value of a choreography and a feature value of a word indicating the choreography in the same feature space and searching for related choreography data from a search query by a natural language.

12. The information processing device according to any one of 1 to 11, further including
a function of analyzing a distribution of feature values of the choreography registered in the database, and in a case where the new choreography is determined to relate to copyright infringement, deforming the feature value of the new choreography into a low density region of the distribution of the feature values to present the choreography avoiding the copyright infringement.

13. The information processing device according to any one of 1 to 12, in which
the posture detection means includes an end-to-end feature extraction function of extracting a feature value from the moving image using an auto encoder, a variational auto encoder, or a deep learning model including a CLIP model.

14. The information processing device according to any one of 1 to 13, in which
the rights management means records registration information, a use history, and reward distribution information of a choreography using a blockchain technique.

15. An information processing method in which one or more computers
detect posture data of a person from a moving image,
extract a feature value of a choreography from the detected posture data and register the feature value in a database,
calculate a similarity between the choreography registered in the database and a new choreography, and
evaluate a possibility of copyright infringement based on the similarity.

16. A program for causing a computer to function as
a posture detection means for detecting posture data of a person from a moving image,
a choreography digitalization means for extracting a feature value of a choreography from the detected posture data and registering the feature value in a database,
a similarity determination means for calculating a similarity between the choreography registered in the database and a new choreography, and
a rights management means for evaluating a possibility of copyright infringement based on the similarity.

Some or all of Supplementary Notes 2 to 14 dependent on the information processing device of Supplementary Note 1 described above can also be dependent on the information processing method of Supplementary Note 15 and the program of Supplementary Note 16 by dependency relationship similar to Supplementary Note 1 and Supplementary Notes 2 to 14. Furthermore, some or all of the configurations described as Supplementary Notes may be achieved in various pieces of hardware, software, various recording means for recording software, or systems without departing from the example embodiments described above.

1. An information processing apparatus comprising:
at least one memory configured to store one or more instructions; and
at least one processor configured to execute the one or more instructions to:
detect posture data of a person from a moving image;
extract a feature value of a choreography from the detected posture data;
register the feature value in a database;
calculate a similarity between the choreography registered in the database and a new choreography; and
evaluate a possibility of copyright infringement based on the similarity.

2. The information processing apparatus according to claim 1, wherein
the at least one processor is further configured to execute the one or more instructions to extract, as a feature value, time-series data including at least one of a relative positional relationship of body parts, a velocity vector, an acceleration vector, and an angular change of a movement.

3. The information processing apparatus according to claim 1, wherein
the at least one processor is further configured to execute the one or more instructions to
provide a threshold value of the similarity, and
notify that there is a possibility of copyright infringement in a case where the similarity exceeds the threshold value.

4. The information processing apparatus according to claim 1, wherein
the at least one processor is further configured to execute the one or more instructions to distribute a reward related to use of the choreography to the choreographer.

5. The information processing apparatus according to claim 1, wherein
the at least one processor is further configured to execute the one or more instructions to manage partial joint copyright of a choreography by a plurality of choreographers.

6. The information processing apparatus according to claim 1, wherein
the at least one processor is further configured to execute the one or more instructions to apply the detected posture data to an avatar and reproducing it with a 3D model.

7. The information processing apparatus according to claim 1, wherein
the at least one processor is further configured to execute the one or more instructions to analyze a difficulty level and a feature of a choreography, and
provide learning support information.

8. The information processing apparatus according to claim 1, wherein
the at least one processor is further configured to execute the one or more instructions to generate a new choreography using a machine learning model, and
evaluate and modify a feasibility and a human body dynamic conformity in a 3D posture estimation system.

9. The information processing apparatus according to claim 1, wherein
the at least one processor is further configured to execute the one or more instructions to evaluate similarity between the choreography generated by the machine learning model and an existing choreography, and
detect and modify a portion having a high risk of copyright infringement.

10. The information processing apparatus according to claim 1, wherein
the at least one processor is further configured to execute the one or more instructions to
perform a correlation analysis between the feature value of the choreography and at least one of the number of reproductions of a moving image site, the number of attendees of a concert, and market data of sales information of a video medium in the database,
measure a value of the choreography based on a result of the correlation analysis, and
perform pricing at the time of selling the choreography based on the value.

11. The information processing apparatus according to claim 1, wherein
the at least one processor is further configured to execute the one or more instructions to
perform learning to embed a feature value of a choreography and a feature value of a word indicating the choreography in the same feature space, and
search for related choreography data from a search query by a natural language.

12. The information processing apparatus according to claim 1, wherein
the at least one processor is further configured to execute the one or more instructions to analyze a distribution of feature values of the choreography registered in the database, and
in a case where the new choreography is determined to relate to copyright infringement, determine the feature value of the new choreography into a low density region of the distribution of the feature values to present the choreography avoiding the copyright infringement.

13. The information processing apparatus according to claim 1, wherein
the at least one processor is further configured to execute the one or more instructions to include an end-to-end feature extraction function of extracting a feature value from the moving image using an auto encoder, a variational auto encoder, or a deep learning model including a CLIP model.

14. The information processing apparatus according to claim 1, wherein
the at least one processor is further configured to execute the one or more instructions to record registration information, a use history, and reward distribution information of a choreography using a blockchain technique.

15. An information processing method in which one or more computers:
detect posture data of a person from a moving image;
extract a feature value of a choreography from the detected posture data;
register the feature value in a database;
calculate a similarity between the choreography registered in the database and a new choreography; and
evaluate a possibility of copyright infringement based on the similarity.

16. The information processing method according to claim 15, wherein
the one or more computers extract, as a feature value, time-series data including at least one of a relative positional relationship of body parts, a velocity vector, an acceleration vector, and an angular change of a movement.

17. The information processing method according to claim 15, wherein
the one or more computers
provide a threshold value of the similarity, and
notify that there is a possibility of copyright infringement in a case where the similarity exceeds the threshold value.

18. A non-transitory computer-readable medium storing a program for causing a computer to:
detect posture data of a person from a moving image;
extract a feature value of a choreography from the detected posture data;
register the feature value in a database;
calculate a similarity between the choreography registered in the database and a new choreography; and
evaluate a possibility of copyright infringement based on the similarity.

19. The non-transitory computer-readable medium according to claim 18, wherein
the program causes the computer to extract, as a feature value, time-series data including at least one of a relative positional relationship of body parts, a velocity vector, an acceleration vector, and an angular change of a movement.

20. The non-transitory computer-readable medium according to claim 18, wherein
the program causes the computer to
provide a threshold value of the similarity, and
notify that there is a possibility of copyright infringement in a case where the similarity exceeds the threshold value.
